(19) United States
(12) Patent Application Publication
(10) Pub. No.: US 2026/0104945 A1
(43) Pub. Date: Apr. 16, 2026

(54) RECEIVE SIDE APPLICATION AUTO-SCALING

(71) Applicant: Telefonaktiebolaget LM Ericsson (publ), Stockholm (SE)

(72) Inventors: Martin JULIEN, Montreal (CA); Dániel GÉHBERGER, Montreal (CA)

(73) Assignee: Telefonaktiebolaget LM Ericsson (publ), Stockholm (SE)

(21) Appl. No.: 19/115,693

(22) PCT Filed: Sep. 30, 2022
(86) PCT No.: PCT/IB2022/059373

§ 371 Date: Mar. 26, 2025

(51) Int. Cl. G06F 9/50

(52) U.S. Cl. CPC G06F 9/5083

(57) ABSTRACT

A method for auto-scaling an application is disclosed. The method includes selecting, by a network interface card (NIC), a queue for an incoming packet using an indirection table, enqueuing, by the NIC, the incoming packet to the selected queue along with the queue information associated with the selected queue, retrieving, by a worker thread of the application associated with the selected queue, the incoming packet from the selected queue, obtaining, by the worker thread, the queue information associated with the selected queue, providing, by the worker thread, the queue information associated with the selected queue to an auto-scaling manager, determining, by the auto-scaling manager, whether the application should be scaled based on analyzing the queue information associated with the selected queue, and providing, by the auto-scaling manager, a scaling determination indicator to a main thread of the application indicating whether the application should be scaled up or scaled down.

### TECHNICAL FIELD

Embodiments of the invention relate to the field of relate to receive side scaling, and more specifically, to auto-scaling an application that uses receive side scaling.

### BACKGROUND

Receive side scaling (RSS) is a network driver technology that enables the distribution of packets received by a network interface card (NIC) across multiple central processing unit (CPU) cores. With conventional RSS, a NIC applies a hash function to metadata and/or header information of a received packet. The resulting hash value is used as an index into an indirection table. The value in the indirection table is used to assign the received packet to one of the available CPU cores. This technique assumes that packets belonging to different traffic flows will typically result in producing different hash values, which would result in different traffic flows being assigned to different CPU cores, thereby creating a certain entropy for traffic flows across all of the available CPU cores.

High-performance applications such as applications implementing data plane functions in a telecom radio or a core network typically use multiple RSS queues to distribute the incoming load. A typical application design approach is that at application initialization, a pre-defined number of RSS queues are created along with dedicated threads that are also typically pinned to specific CPU cores. Data Plane Development Kit (DPDK), which is one of the most widely used packet processing frameworks, follows this design approach.

Dynamically scaling applications is a key feature that represents a cost saving asset in cloud deployments. This is especially true for packet processing applications in telecom networks, where the daily load fluctuation is significant.

Applications can be scaled by scaling up/down or scaling out/in. An application can be scaled up/down by adding/removing resources that are allocated to the application. An application can be scaled out/in by adding/removing instances of the application. It is important for an application to be scaled appropriately and quickly in response to changing loads. Otherwise, situations may occur where the application is under-allocated resources (in which case application performance may suffer) and/or the application is over-allocated resources (in which case resources are not being used efficiently).

### SUMMARY

A method is performed by a computing system for auto-scaling an application is disclosed. The method includes receiving, by a network interface card (NIC), an incoming packet, selecting, by the NIC, a queue for the incoming packet using an indirection table, determining, by the NIC, queue information associated with the selected queue, enqueuing, by the NIC, the incoming packet to the selected queue along with the queue information associated with the selected queue, retrieving, by a worker thread of the application associated with the selected queue, the incoming packet from the selected queue, obtaining, by the worker thread, the queue information associated with the selected queue, providing, by the worker thread, the queue information associated with the selected queue to an auto-scaling manager, determining, by the auto-scaling manager, whether the application should be scaled based on analyzing the queue information associated with the selected queue, responsive to a determination that the application should be scaled, providing, by the auto-scaling manager, a scaling determination indicator to a main thread of the application indicating whether the application should be scaled up or scaled down, scaling, by the main thread, the application based on the scaling determination indicator, and updating, by the auto-scaling manager, the indirection table to reflect an addition of a new queue or a removal of an existing queue due to the scaling.

A method performed by an auto-scaling manager implemented by a computing system to determine whether an application should be scaled is disclosed. The method includes obtaining queue information associated with one or more queues of a NIC, wherein each of the one or more queues is associated with a worker thread of the application, determining whether the application should be scaled based on analyzing the queue information associated with the one or more queues, and responsive to a determination that the application should be scaled, providing a scaling determination indicator to a main thread of the application indicating whether the application should be scaled up or scaled down.

A non-transitory machine-readable storage medium is disclosed herein that provides instructions that, if executed by one or more processors of a computing system implementing an auto-scaling manager, causes the computing system to carry out operations for determining whether an application should be scaled. The operations include obtaining queue information associated with one or more queues of a NIC, wherein each of the one or more queues is associated with a worker thread of the application, determining whether the application should be scaled based on analyzing the queue information associated with the one or more queues, and responsive to a determination that the application should be scaled, providing a scaling determination indicator to a main thread of the application indicating whether the application should be scaled up or scaled down.

A computing device is disclosed herein to implement an auto-scaling manager to determine whether an application should be scaled. The computing device includes a set of one or more processors and a non-transitory machine-readable storage medium containing instructions that, if executed by the set of one or more processors, causes the computing device to obtain queue information associated with one or more queues of a NIC, wherein each of the one or more queues is associated with a worker thread of the application, determine whether the application should be scaled based on analyzing the queue information associated with the one or more queues, and responsive to a determination that the application should be scaled, provide a scaling determination indicator to a main thread of the application indicating whether the application should be scaled up or scaled down.

A method performed by a main thread of an application executed by a computer system for auto-scaling the application is disclosed. The method includes obtaining, from an auto-scaling manager, a scaling determination indicator indicating whether the application should be scaled up or scaled down and a queue ID and scaling the application based on the scaling determination indicator and the queue ID.

A non-transitory machine-readable storage medium is disclosed herein that provides instructions that, if executed by one or more processors of a computing system executing an application, causes the computing system to carry out operations for auto-scaling the application. The operations include obtaining, from an auto-scaling manager, a scaling determination indicator indicating whether the application should be scaled up or scaled down and a queue ID and scaling the application based on the scaling determination indicator and the queue ID.

A computing device is disclosed herein to execute a main thread of an application. The computing device includes a set of one or more processors and a non-transitory machine-readable storage medium containing instructions that, if executed by the set of one or more processors, causes the computing device to obtain, from an auto-scaling manager, a scaling determination indicator indicating whether the application should be scaled up or scaled down and a queue ID and scale the application based on the scaling determination indicator and the queue ID.

### BRIEF DESCRIPTION OF THE DRAWINGS

The invention may best be understood by referring to the following description and accompanying drawings that are used to illustrate embodiments of the invention. In the drawings:

FIG. 1 is a diagram showing example operations for providing queue information to worker threads of an application, according to some embodiments.

FIG. 2 is a diagram showing an auto-scaling manager and its interactions with other components, according to some embodiments.

FIG. 3 is a diagram showing operations when an application decides to accept a scale up recommendation provided by the auto-scaling manager, according to some embodiments.

FIG. 4 is a diagram showing operations when an application decides to accept a scale down recommendation provided by the auto-scaling manager, according to some embodiments.

FIG. 5 is a flow diagram showing a method for enqueuing an incoming packet to a queue with queue information, according to some embodiments.

FIG. 6 is a flow diagram showing a method for processing a packet, according to some embodiments.

FIG. 7 is a diagram showing interactions between the auto-scaling manager and other components, according to some embodiments.

FIG. 8 is a diagram showing an example list of configuration parameters that can be used when determining whether an application should be scaled up or scaled down, according to some embodiments.

FIG. 9 is a diagram showing internal components of the auto-scaling manager, according to some embodiments.

FIG. 10 is a flow diagram showing a method for providing a scaling recommendation to an application, according to some embodiments.

FIG. 11 is a diagram showing operations when an application accepts a scale up recommendation provided by an auto-scaling manager, according to some embodiments.

FIG. 12 is a diagram showing an example of how an auto-scaling manager updates the indirection table when the application is scaled up, according to some embodiments.

FIG. 13 is a flow diagram showing a method for scaling up, according to some embodiments.

FIG. 14 is a flow diagram showing a method for trying to apply new settings for scaling up, according to some embodiments.

FIG. 15 is a flow diagram showing a method for trying to create a new worker thread to scale up an application, according to some embodiments.

FIG. 16 is a flow diagram showing a method for assisting with an application scale up, according to some embodiments.

FIG. 17 is a diagram showing operations when an application accepts a scale down recommendation provided by an auto-scaling manager, according to some embodiments.

FIG. 18 is a diagram showing an example of how an auto-scaling manager updates the indirection table when the application is scaled down, according to some embodiments.

FIG. 19 is a flow diagram showing a method for scaling down, according to some embodiments.

FIG. 20 is a flow diagram showing a method for trying to apply new settings for scaling down, according to some embodiments.

FIG. 21 is a flow diagram showing a method for assisting with an application scale down, according to some embodiments.

FIG. 22 is a flow diagram showing a method for terminating a worker thread to scale down an application, according to some embodiments.

FIG. 23 is a flow diagram showing a method for auto-scaling an application, according to some embodiments.

FIG. 24A illustrates connectivity between network devices (NDs) within an exemplary network, as well as three exemplary implementations of the NDs, according to some embodiments of the invention.

FIG. 24B illustrates an exemplary way to implement a special-purpose network device according to some embodiments of the invention.

FIG. 25 is a diagram showing a NIC, according to some embodiments.

### DETAILED DESCRIPTION

The following description describes methods and apparatuses for auto-scaling an application that uses receive side scaling (RSS). In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of embodiments. It will be appreciated, however, by one skilled in the art that embodiments may be practiced without such specific details. In other instances, control structures, gate level circuits and full software instruction sequences have not been shown in detail in order not to obscure the disclosure. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments. However, such notation should not be taken to mean that these are the only options or optional operations, and/or that blocks with solid borders are not optional in certain embodiments.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical Nis (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, brid ging, switching, Layer 2 aggregation, session border control, Quality of Service, and/or subscriber management), and/or provide support for multiple application services (e.g., data, voice, and video).

Embodiments are disclosed herein that enhance conventional RSS solutions by introducing an active queue management component that marks incoming packets with queue information (e.g., queue occupancy information). The queue information may be provided to an auto-scaling manager. The auto-scaling manager may collect and store queue information for multiple queues. The auto-scaling manager may use the queue information to determine whether an application should be scaled up or scaled down in terms of the number of queues/threads that are used by the application to process packets. If the auto-scaling manager determines that the application should be scaled up or scaled down, the auto-scaling manager may provide a corresponding scaling recommendation to the application. The application may decide to accept or reject the scaling recommendations provided by the auto-scaling manager.

The application may be scaled up by creating a new application worker thread associated with a new queue or be scaled down by terminating an existing application worker thread associated with an existing queue. The application may provide an indication to the auto-scaling manager of whether the application accepts or rejects the scaling recommendation. If the application accepts the scaling recommendation provided by the auto-scaling manager, the auto-scaling manager may update system resources to reflect the scaling of the application, for example, by updating indirection table entries to reflect the addition of a new queue or removal of an existing queue due to the scaling. The auto-scaling manager may leverage the queue information that it collected and stored when updating the indirection table to try to distribute future incoming packets across the available queues/threads in a balanced manner.

The RSS feature is generally available in common NICs and smartNICs. Active Queue Management (AQM) is a feature that is generally available in common Ethernet network switches and/or Internet Protocol (IP) routers. AQM is typically used to perform explicit congestion notification (e.g., to slow down a sender). Embodiments use the AQM concept to provide queue information to an auto-scaling manager for application auto-scaling purposes. Thus, embodiments apply the concept of AQM in a different/unexpected way and for a different purpose compared to conventional AQM.

An embodiment is a method performed by a computing system for auto-scaling an application. The method includes receiving, by a network interface card (NIC), an incoming packet, selecting, by the NIC, a queue for the incoming packet using an indirection table, determining, by the NIC, queue information associated with the selected queue, enqueuing, by the NIC, the incoming packet to the selected queue along with the queue information associated with the selected queue, retrieving, by a worker thread of the application associated with the selected queue, the incoming packet from the selected queue, obtaining, by the worker thread, the queue information associated with the selected queue, providing, by the worker thread, the queue information associated with the selected queue to an auto-scaling manager, determining, by the auto-scaling manager, whether the application should be scaled based on analyzing the queue information associated with the selected queue, responsive to a determination that the application should be scaled, providing, by the auto-scaling manager, a scaling determination indicator to a main thread of the application indicating whether the application should be scaled up or scaled down, scaling, by the main thread, the application based on the scaling determination indicator, and updating, by the auto-scaling manager, the indirection table to reflect an addition of a new queue or a removal of an existing queue due to the scaling.

Embodiments provide one or more technological advantages.

Since every packet (or almost every packet) can be marked with queue information at runtime and provided to the auto-scaling manager, the auto-scaling manager may have up-to-date and accurate queue occupancy information for the (RSS) queues. This allows the auto-scaling manager to quickly detect significant changes to queue occupancy levels and to make appropriate scaling recommendations for the application in response thereto.

Embodiments provide an application with the flexibility to decide whether to accept or reject the scaling recommendation provided by the auto-scaling manager. That is, an application is not required to follow the scaling recommendation provided by the auto-scaling manager. Also, an application is allowed to scale itself up or down by creating/terminating worker threads (and adding/removing queues) or using other means. For example, an application might prefer to adapt to changing load by first applying new application-specific settings before creating/terminating worker threads.

Embodiments minimize the impacts of dynamically scaling an application using coordination between the auto-scaling manager and the application. For example, embodiments provide a coordinated/graceful way to migrate traffic flows between application worker threads in a manner that guarantees packet ordering when the application is scaled up or scaled down.

Embodiments may collect and store queue information for multiple queues and leverage this information when updating the indirection table to try to distribute future incoming packets across the available queues/threads in a balanced manner.

Embodiments provide configuration parameters that can be used to customize the behavior of the auto-scaling manager for making scaling recommendations to an application.

Embodiments are aligned with and adapted for use with typical software architectures used by applications requiring high performance (e.g., applications that use the DPDK framework).

While certain technological advantages are mentioned above, other technological advantages of embodiments disclosed herein will be apparent to those skilled in the technical art in view of the present disclosure. Various embodiments are now described with reference to the accompanying figures.

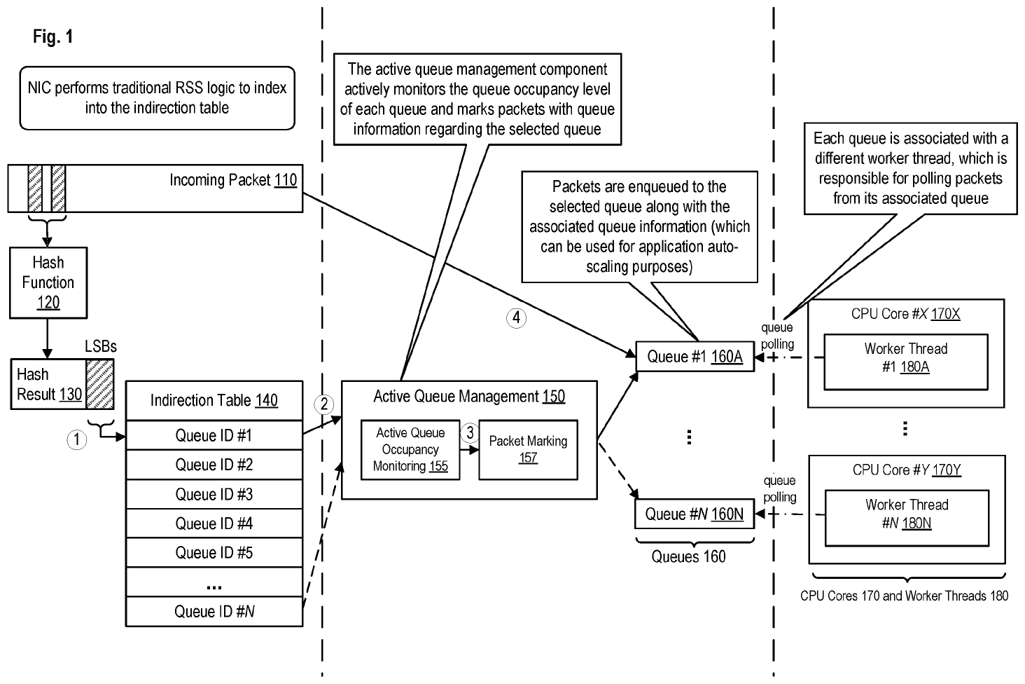

FIG. 1 is a diagram showing example operations for providing queue information to worker threads of an application, according to some embodiments.

A network interface card (NIC) may perform traditional RSS logic to index into an (RSS) indirection table 140. For example, when the NIC receives an incoming packet 110, the NIC may apply a hash function 120 to the header of the incoming packet 110 and/or metadata associated with the packet 110 to generate a hash result 130. The hash function 120 that the NIC applies may be configurable. In an embodiment, the hash function 120 is based on a Toeplitz algorithm, a XOR algorithm, or cyclic redundancy check 32 (CRC32) algorithm, but other types of hash functions may be used. As shown in the diagram, at operation 1, the NIC determines an index into the indirection table 140 based on the hash result 130. For example, as shown in the diagram, the NIC may use the N least significant bits of the hash result 130 to determine the index into the indirection table 140. Each entry of the indirection table 140 may be linked to a (RSS) queue 160. For example, in the example shown in the diagram, the first entry of the indirection table 140 is linked to queue #1 160A (the entry indicates the ID of queue #1 160A) and the last entry is linked to queue #N 160N (the entry indicates the ID of queue #N 160N). In the example shown in the diagram, it is assumed that the index points to the first entry of the indirection table 140, which is linked to queue #1 160A. Thus, queue #1 160A is the queue 160 that is selected for the incoming packet 110.

As shown in the diagram, the NIC may include an active queue management component 150. The active queue management component 150 may include an active queue occupancy monitoring component 155 and a packet marking component 157. The active queue occupancy monitoring component 155 may actively monitor the queue occupancy level of each queue 160. The packet marking component 157 may mark incoming packets with queue information.

As shown in the diagram, at operation 2, the NIC invokes the active queue management component 150. The active queue occupancy monitoring component 155 may determine the current queue occupancy level of the selected queue (queue #1 160A in this example). At operation 3, the active queue occupancy monitoring component 155 may provide the current queue occupancy level of the selected queue 160A to the packet marking component 157. The packet marking component 157 may mark the incoming packet 110 with queue information associated with the selected queue (including information regarding the current queue occupancy level of the selected queue 160A).

In an embodiment, the packet marking component 157 marks the incoming packet 110 with queue information by adding queue information to the header of the incoming packet 110 (e.g. a pre-prepended header, IPv4/v6 extensions, etc.). Additionally or alternatively, in an embodiment, the packet marking component 157 marks the incoming packet 110 with queue information by adding the queue information to metadata associated with the incoming packet. For example, in the case of DPDK-based applications, the packet marking component 157 may add queue information to the DPDK memory buffer structure (struct rte_mbuf) associated with the incoming packet 110. The DPDK metadata already includes the hash value associated with a packet, so it is considered that the queue information may fit well into that pre-existing structure of packet metadata information.

At operation 4, the NIC enqueues the incoming packet 110 to the selected queue 160 (queue #1 160A in this example) along with the queue information associated with the selected queue 160. As will be described in additional detail herein, the queue information may be used for application auto-scaling purposes.

An application may be executed by one or more CPU cores 170. The CPU cores 170 may be CPU cores of a multi-core system. Each CPU core 170 may execute a worker thread 180 of the application. For example, as shown in the diagram, CPU core #X 170X may execute worker thread #1 180A and CPU core #Y may execute worker thread #N 180N. Each worker thread 180 may be associated with one of the queues 160 and poll its associated queue 160 for packets. For example, in the example shown in the diagram, worker thread #1 180A is associated with queue #1 160A and may poll queue #1 160A for packets and worker thread #N 180N is associated with queue #N 160N and may poll queue #N 160N for packets. Thus, a worker thread 180 may retrieve packets and any queue information accompanying those packets from its associated queue 160. In the example shown in the diagram, the NIC enqueues the incoming packet 110 to queue #1 160A (since this is the selected queue) and the worker thread #1 180A may retrieve the incoming packet 110 and accompanying queue information from queue #1 160A (based on polling queue #1 160A).

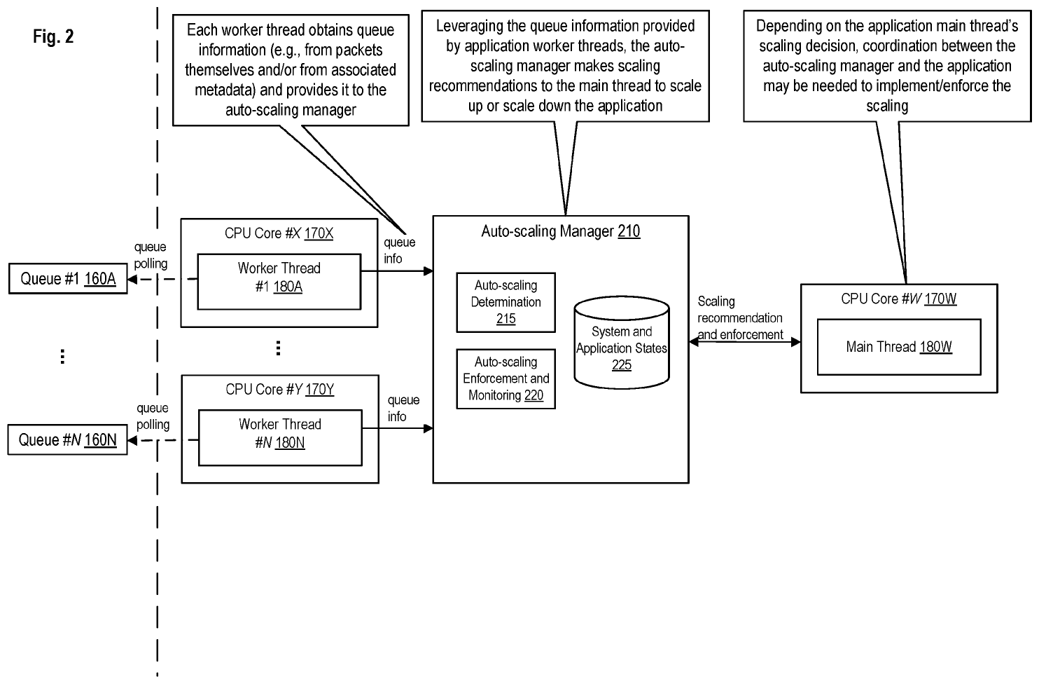

FIG. 2 is a diagram showing an auto-scaling manager and its interactions with other components, according to some embodiments.

As mentioned above, each worker thread 180 may poll its associated queue 160 to retrieve packets and any accompanying queue information. Each worker thread 180 may extract the queue information accompanying the packets (e.g., from the packet header and/or from metadata associated with the packet) and provide this queue information to the auto-scaling manager 210. In an embodiment, the queue information includes information regarding the current queue occupancy level. For example, worker thread #1 180A (executing on CPU core #X 170X) may retrieve packets from queue #1 160A (based on polling queue #1 160A), extract queue information accompanying those packets (which is queue information associated with queue #1 160A), and provide this queue information to the auto-scaling manager 210. Similarly, worker thread #N 180N (executing on CPU core #Y 170Y) may retrieve packets from queue #N 160N (based on polling queue #N 160N), extract queue information accompanying those packets (which is queue information associated with queue #N 160N), and provide this queue information to the auto-scaling manager 210. Once a worker thread 180 provides the queue information accompanying a packet to the auto-scaling manager 210, the worker thread 180 is free to process the packet normally. In an embodiment, a worker thread 180 provides queue information to the auto-scaling manager 210 in batches (e.g., instead of per packet if this is considered more efficient).

As shown in the diagram, the auto-scaling manager 210 includes an auto-scaling determination component 215 and an auto-scaling enforcement and monitoring component 220. The auto-scaling determination component 215 may determine whether the application should be scaled up or scaled down based on analyzing the queue information provided by the worker threads 180. In an embodiment, the auto-scaling determination component 215 also takes into consideration other information besides the queue information when determining whether the application should be scaled up or scaled down. For example, the auto-scaling determination component 215 may also take into account other system and application state information (e.g., the indirection table configuration) when determining whether the application should be scaled up or scaled down. The queue information provided by the worker thread 180 and/or the other system state and configuration information that the auto-scaling manager 210 can use to make scaling recommendations for applications may be stored in storage 225. If the auto-scaling determination component 215 determines that the application should be scaled up or scaled down, then the auto-scaling manager 210 may provide a corresponding recommendation to the main thread 180W of the application to scale up or scale down the application.

The main thread 180W is a worker thread of the application that is responsible for receiving scaling recommendations from the auto-scaling manager and implement application-specific behavior regarding how to scale the application. The main thread 180W may decide to accept or reject the scaling recommendation provided by the auto-scaling manager 210. If the main thread 180W accepts the scaling decision, the application may coordinate with the auto-scaling enforcement and monitoring component 220 to enforce/implement the scaling (e.g., to update the indirection table to reflect the effects of the scaling). The auto-scaling enforcement and monitoring component 220 may provide the required support to applications to enforce scaling decisions. It may also provide further insights regarding the already collected information (e.g., scaling history and trends).

The auto-scaling determination component 215 may continuously collect queue information from the worker threads 180, determine whether the application should be scaled up or scaled down based on analyzing up-to-date queue information, and provide scaling recommendations to the main thread 180W in a similar manner as described above.

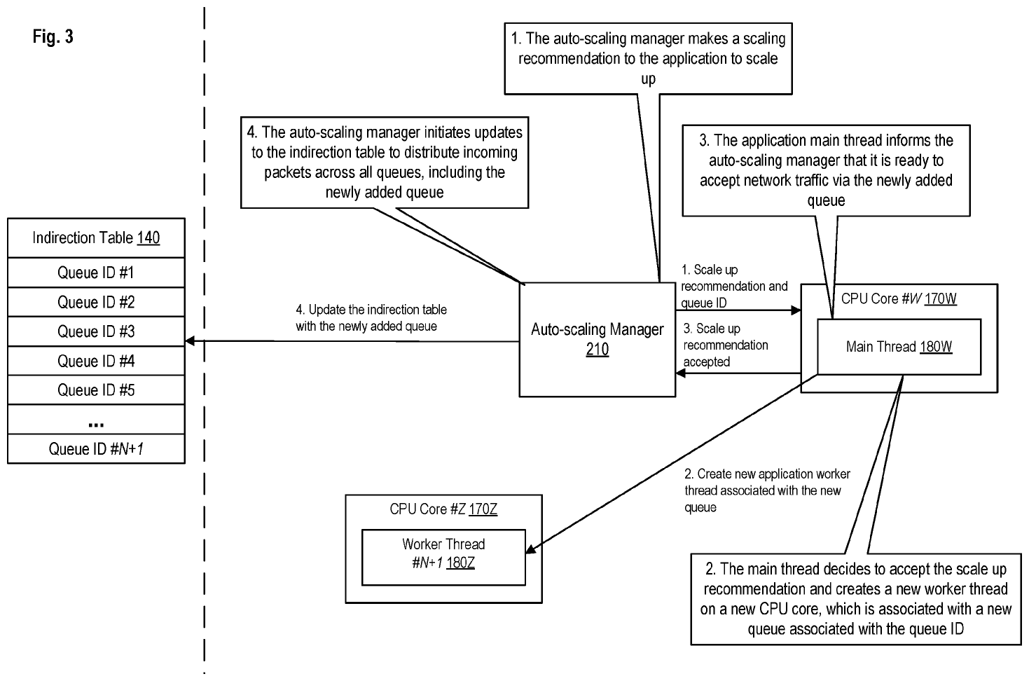

FIG. 3 is a diagram showing operations when an application decides to accept a scale up recommendation provided by the auto-scaling manager, according to some embodiments.

At operation 1, the auto-scaling manager 210 provides a scaling recommendation to the application to scale up (a scale up recommendation). The scale up recommendation may be accompanied by a queue ID for a new queue that is to be added for scaling up. As previously mentioned, the application may decide whether to accept or reject the scaling recommendation. In this example, at operation 2, the main thread 180W decides to accept the scale up recommendation and thus creates a new worker thread #N+1 180Z on a new CPU core #Z 170Z and associates the new worker thread #Z 180Z with a new queue 160 associated with the queue ID provided by the auto-scaling manager 210. Thus, the new worker thread #N+1 180Z may be configured to poll the new queue 160 for packets. For example, assuming the application already has five worker threads 180 associated with five queues 160, adding a new worker thread 180 and a new queue 160 would make the application capable of receiving incoming packets using six worker threads 180 and six queues 160. Having more worker threads 180 and more queues 160 is a way for the application to scale up in terms of packet processing capacity. Once the new worker thread #N+1 180Z is created, at operation 3, the main thread 180W may provide an indication to the auto-scaling manager 210 that it accepted the scale up recommendation and that it is ready to accept network traffic from the new queue 160. At operation 4, the auto-scaling manager 210 initiates updates to the indirection table 140 to distribute future incoming packets across all available queues 160, including the new queue, in a balanced manner.

For example, assuming that the auto-scaling manager 210 determined that the application should be scaled up based on detecting one or more congested queues 160, the auto-scaling manager 210 may update the indirection table such that one or more entries currently linked to the congested queues 160 are updated to be linked to the new queue 160. This may cause less packets to be sent to the congested queues 160 and cause packets to be sent to the new queue 160. Thus, the newly created worker thread #N+1 180Z may start retrieving packets from the new queue 160. At this point, the application has successfully scaled up.

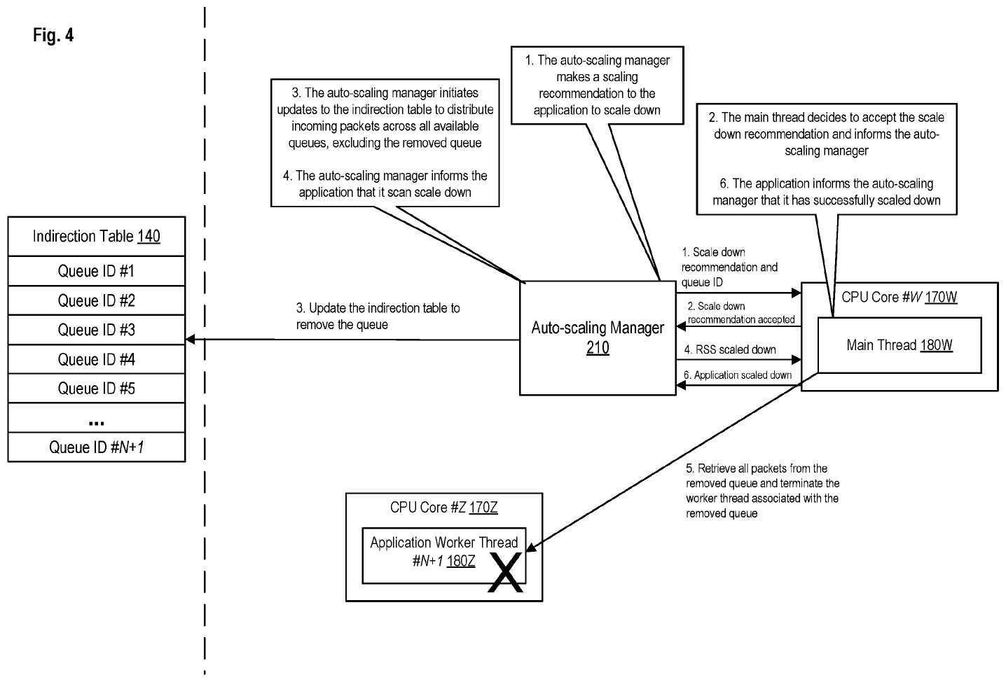

FIG. 4 is a diagram showing operations when an application decides to accept a scale down recommendation provided by the auto-scaling manager, according to some embodiments.

At operation 1, the auto-scaling manager 210 provides a scaling recommendation to the application to scale down (a scale down recommendation). The scale down recommendation may be accompanied by a queue ID of an underutilized queue 160. As previously mentioned, the application may decide whether to accept or reject the scaling recommendation. In this example, at operation 2, the main thread 180W decides to accept the scale down recommendation and thus provides an indication to the auto-scaling manager 210 that it accepts the scale down recommendation. The main thread 180W may scale down the application by terminating a worker thread 180 and removing its associated queue 160. Assuming the application already has six worker threads 180 associated with six queues 160, terminating a worker thread 180 and removing a queue 160 would make the application capable of receiving incoming packets using five worker threads 180 and five queues 160. Having less worker threads 180 and less queues 160 is a way for the application to scale down in terms of packet processing capacity. However, before the main thread 180W can terminate a worker thread 180, incoming packets need to stop being enqueued to the queue 160 associated with the worker thread. As will be described in additional detail herein, the auto-scaling manager may assist with ensuring this.

At operation 3, upon receiving an indication that the application has accepted the scale down recommendation, the auto-scaling manager 210 initiates updates to the indirection table 140 to distribute future incoming packets across all available queues 160, excluding the queue 160 to be removed. For example, assuming that the auto-scaling manager 210 determines that the application should be scaled down based on detecting one or more underutilized queues 160, the auto-scaling manager 210 may update the indirection table 140 such that any entries linked to the underutilized queues 160 are updated to be linked to a different queue 160 so that future incoming packets are distributed across all available queues 160 (excluding the underutilized queues 160) in a balanced manner. Once the indirection table 140 is updated, no more incoming packets will be enqueued to the underutilized queues 160.

At operation 4, the auto-scaling manager 210 provides an indication to the main thread 180W that the application can be scaled down (“RSS scaled down”). In response, at operation 5, the main thread 180W requests that the worker thread 180 associated with the underutilized queue 160 (worker thread #N+1 180Z in this example) retrieve all the packets from its associated queue 160. Once all packets have been retrieved from the queue 160, the main thread 180W may terminate worker thread #N+1 180Z. At operation 6, the main thread 180W provides an indication to the auto-scaling manager 210 that the application has successfully scaled down.

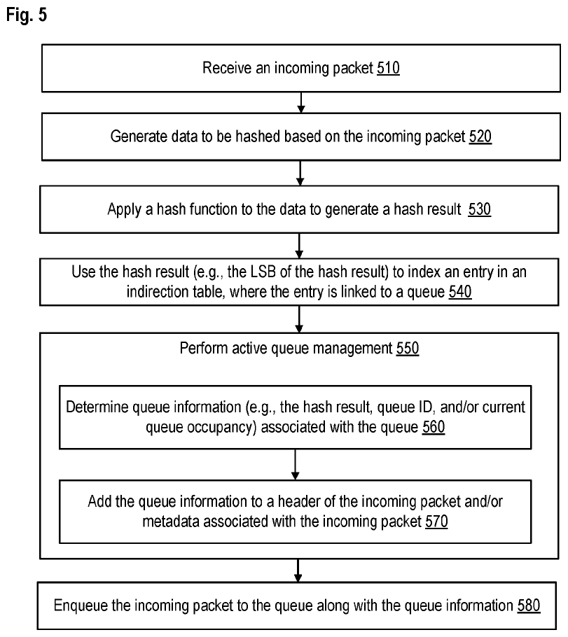

FIG. 5 is a flow diagram showing a method for enqueuing an incoming packet to a queue with queue information, according to some embodiments. The method may be performed by a NIC.

The operations in the flow diagrams will be described with reference to the exemplary embodiments of the other figures. However, it should be understood that the operations of the flow diagrams can be performed by embodiments other than those discussed with reference to the other figures, and the embodiments discussed with reference to these other figures can perform operations different than those discussed with reference to the flow diagrams.

While the flow diagrams in the figures show a particular order of operations performed by certain embodiments, it should be understood that such order is provided by way of example and not to limit embodiments to a particular order (e.g., alternative embodiments may perform the operations in a different order, combine certain operations, overlap certain operations, etc.).

At operation 510, the NIC receives an incoming packet. At operation 520, the NIC generates data to be hashed based on the incoming packet (e.g., the data may be generated based on the header of the incoming packet and/or metadata associated with the incoming packet). At operation 530, the NIC applies a hash function to the data to generate a hash result. At operation 540, the NIC uses the hash result (e.g., the LSB of the hash result) to index an entry of an indirection table, where the entry is linked to a queue. At operation 550, the NIC performs active queue management, which may involve performing operations 560 and 570. At operation 560, the NIC determines queue information (e.g., the hash result, queue ID, and/or current queue occupancy) associated with the queue. At operation 570, the NIC adds the queue information to a header of the incoming packet and/or metadata associated with the incoming packet. At operation 580, the NIC enqueues the incoming packet to the queue along with the queue information.

It should be noted that existing AQM techniques mark packets with a bit that indicates the packet is eligible for discarding but does not provide detailed queue information, as described herein.

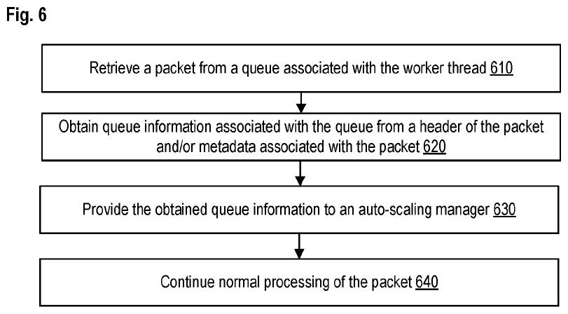

FIG. 6 is a flow diagram showing a method for processing a packet, according to some embodiments. The method may be performed by an application worker thread. At operation 610, the worker thread retrieves a packet from a queue associated with the worker thread. At operation 620, the worker thread obtains/extracts queue information associated with the queue from a header of the packet and/or metadata associated with the packet. At operation 630, the worker thread provides the obtained/extracted queue information to an auto-scaling manager. At operation 640, the worker thread continues normal processing of the packet.

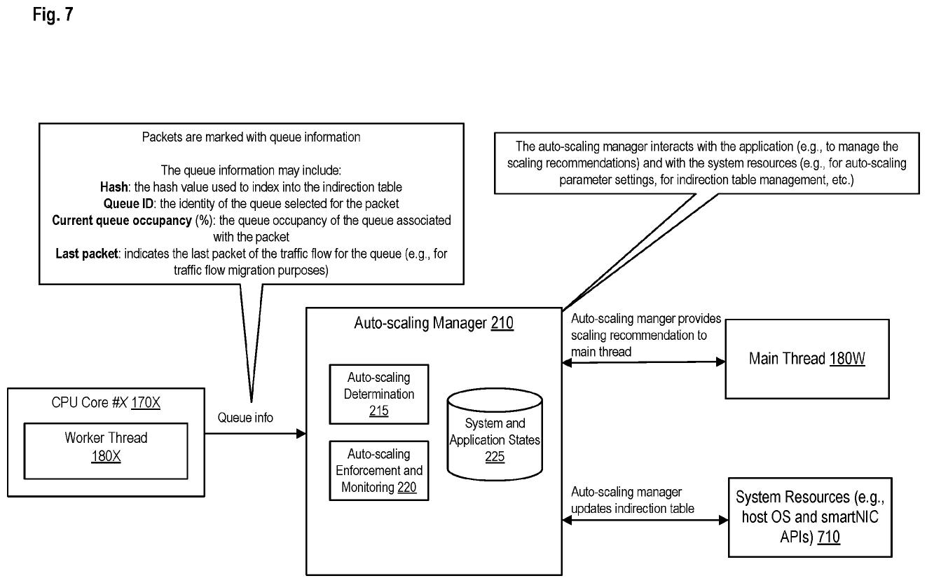

FIG. 7 is a diagram showing interactions between the auto-scaling manager and other components, according to some embodiments. As shown in the diagram, the auto-scaling manager 210 may interact with worker threads 180 of an application, the main thread 180W of the application, and system resources 710.

As previously mentioned, worker threads 180 of the application may provide queue information to the auto-scaling manager 210. For example, as shown in the diagram, worker thread 180X being executed by CPU core #X 170X may provide queue information to the auto-scaling manager 210. As shown in the diagram, in an embodiment, the queue information includes a hash value, a queue ID, a current queue occupancy level, and/or a last packet indicator. The hash value may be the hash value that was used to index into the indirection table to select a queue for the incoming packet. The queue ID may be the identify of the queue that was selected for the incoming packet (the queue that the incoming packet was enqueued into). The current queue occupancy level may indicate the current queue occupancy level of the queue associated with the incoming packet (e.g., expressed in terms of percentage of the queue capacity that is occupied). The last packet indicator may be a flag that indicates whether the incoming packet is the last packet of the traffic flow for the queue (as will be described in further detail herein, this may be used for traffic flow migration purposes).

The auto-scaling manager 210 may provide scaling recommendations to the main thread 180W (or other worker thread capable of interacting with the auto-scaling manager 210). The main thread 180W may decide to accept or reject scaling recommendations provided by the auto-scaling manager. If the main thread 180W decides to accept a scaling recommendation, the main thread 180W may scale the application (scale up or scale down) based on the scaling recommendation.

The auto-scaling manager 210 may interact with the system resources 710 to obtain system-related information (e.g. smart NIC settings, statistics, etc.) and/or to update system-related configurations (e.g. indirection table configuration).

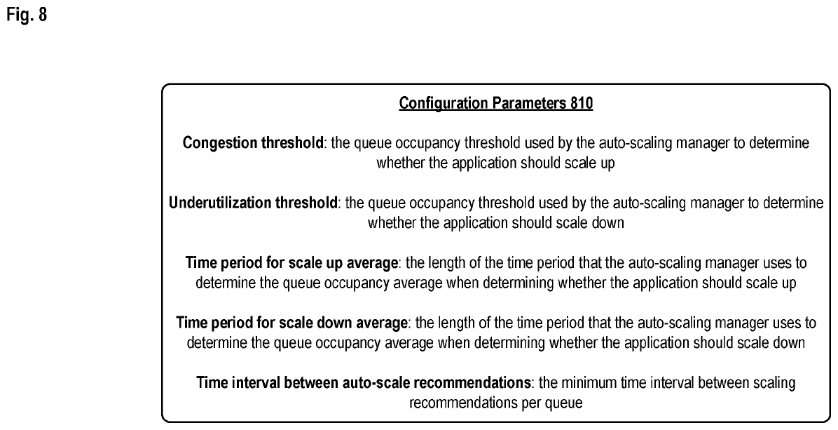

FIG. 8 is a diagram showing an example list of configuration parameters that can be used when determining whether an application should be scaled up or scaled down, according to some embodiments. As shown in the diagram, the list of configuration parameters 810 includes a “congestion threshold” configuration parameter, a “underutilization threshold” configuration parameter, a “time period for scale up average” configuration parameter, a “time period for scale down average” configuration parameter, and a “time interval between auto-scale recommendations” configuration parameter. The “congestion threshold” configuration parameter may indicate the queue occupancy threshold that is to be used by the auto-scaling manager 210 to determine whether the application should be scaled up. The “underutilization threshold” configuration parameter may indicate the queue occupancy threshold that is to be used by the auto-scaling manager 210 to determine when the application should be scaled down. The “time period for scale up average” configuration parameter may indicate the length of the time period that the auto-scaling manager 210 uses to determine the queue occupancy average when determining whether the application should be scaled up. The “time period for scale down average” configuration parameter may indicate the length of the time period that the auto-scaling manager 210 uses to determine the queue occupancy average when determining whether the application should be scaled down. The values of the “time period for scale up average” configuration parameter and the “time period for scale down average” configuration parameter may be configured to avoid the thresholds being reached too often and/or to help control the responsiveness of detecting queue congestion and queue underutilization. The values of the “time period for scale up average” configuration parameter and the “time period for scale down average” configuration parameter may be the same in some embodiments or different. The “time interval between auto-scale recommendations” configuration parameter may indicate the minimum time interval between scaling recommendations provided to the application per queue. The value of the “time interval between recommendations” parameter may be configured to control how often the application is provided a new scaling recommendation.

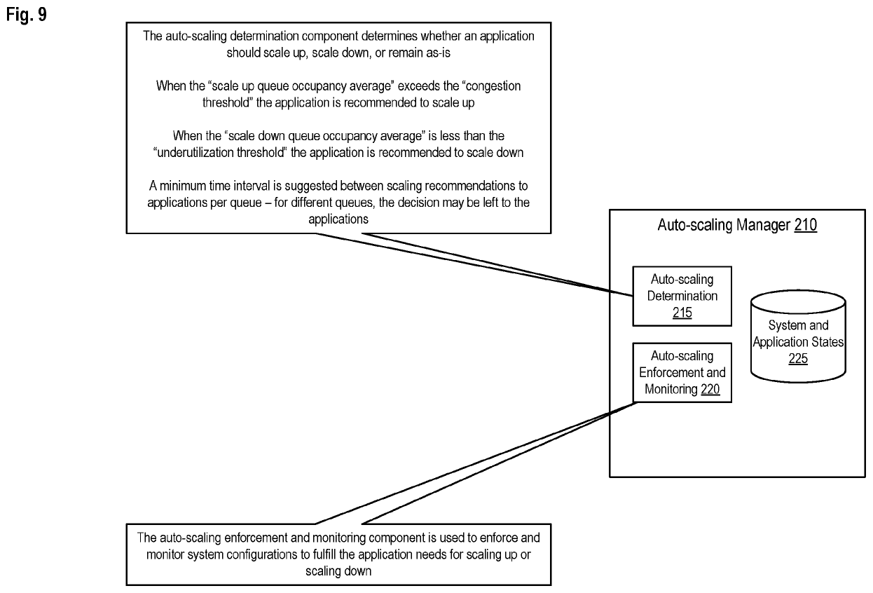

FIG. 9 is a diagram showing internal components of the auto-scaling manager, according to some embodiments.

As shown in the diagram, the auto-scaling manager 210 includes an auto-scaling determination component 215, an auto-scaling enforcement and monitoring component 220, and a storage 225 for system and application states.

As previously mentioned, the auto-scaling determination component 215 may determine whether an application should be scaled up or scaled down (or remain as-is). In an embodiment, the auto-scaling determination component 215 determines that the application should be scaled up when the “scale up queue occupancy average” exceeds the “congestion threshold.” The “scale up queue occupancy average” for a queue may be calculated as the average queue occupancy level of the queue over a time period having a length that is equivalent to the “time period for scale up average” parameter. Depending on the settings of the “time period for scale up average” parameter, the scaling recommendation may be more or less responsive to rapid changes in queue occupancy levels.

In an embodiment, the auto-scaling determination component 215 may determine that the application should be scaled down when the “scale down queue occupancy average” is less than the “underutilization threshold.” The “scale down queue occupancy average” for a queue may be calculated as the average queue occupancy level of the queue over a time period having a length that is equivalent to the “time period for scale down average” parameter. Depending on the settings of the “time period for scale down average” parameter, the scaling recommendation may be more or less responsive to rapid changes in queue occupancy levels.

It may be beneficial to have a minimum time interval between scaling recommendations per queue. The value of the “time interval between recommendations” parameter may be configured to control the minimum time interval. In an embodiment, there is one “time interval between recommendations” parameter that applies to all queues. In an embodiment, the “time interval between recommendations” parameter can be configured on a per queue basis, if needed. For different queues, the decision of the minimum time interval between recommendations may be made by the application.

The auto-scaling enforcement and monitoring component 220 may enforce and monitor system configurations to fulfill the application needs for scaling up or scaling down. For example, the auto-scaling enforcement and monitoring component 220 may assist with updating the indirection table to reflect the effects of application scaling.

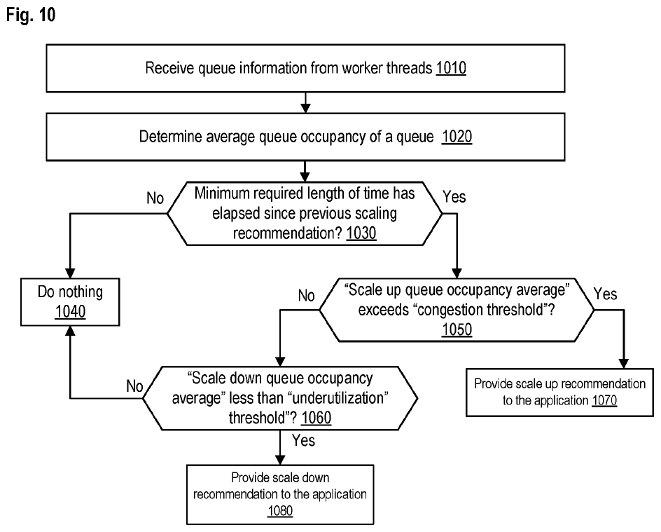

FIG. 10 is a flow diagram showing a method for providing a scaling recommendation to an application, according to some embodiments. The method may be performed by an auto-scaling manager. At operation 1010, the auto-scaling manager receives queue information from worker threads. At operation 1020, the auto-scaling manager determines an average queue occupancy of a queue over a time period (based on analyzing the queue information associated with the queue). The length of the time period may be configurable using the “time period for scale up average” parameter or “time period for scale down average” parameter. At operation 1030, the auto-scaling manager determines whether the minimum required length of time has elapsed since the previous scaling recommendation. The minimum required length of time may be configurable using the “time interval between recommendations” parameter. If the minimum required length of time has not elapsed since the previous scaling recommendation, at operation 1040, the auto-scaling manager does nothing. Otherwise, if the auto-scaling manager determines that the minimum required length of time has elapsed since the previous scaling recommendation, then at operation 1050, the auto-scaling manager determines whether the “scale up queue occupancy average” exceeds the “congestion threshold.” If so, at operation 1070, the auto-scaling manager provides a scale up recommendation to the application. Otherwise, if the auto-scaling manager determines that the “scale up queue occupancy average” does not exceed the “congestion threshold,” then at operation 1060, the auto-scaling manager determines whether the “scale down queue occupancy average” is less than the “underutilization threshold.” If so, at operation 1080, the auto-scaling manager provides a scale down recommendation to the application. Otherwise, if the auto-scaling manager determines that the “scale down queue occupancy average” is not less than the “underutilization threshold,” then at operation 1040, the auto-scaling manager does nothing.

FIG. 11 is a diagram showing operations when an application accepts a scale up recommendation provided by an auto-scaling manager, according to some embodiments. The diagram is similar to the diagram shown in FIG. 3 but highlights a few notable features. It should be understood that the descriptions provided above with reference to FIG. 3 may apply here but those descriptions are not repeated here for sake of brevity.

As noted in the diagram, the auto-scaling manager 210 may provide a scaling recommendation to the application to scale up. If the application decides to reject the scale up recommendation then it may inform the auto-scaling manager 210 of this decision. In response, the auto-scaling manager 210 does not make any changes related to the number of queues available to the application. Otherwise, if the application decides to accept the scale up recommendation then it may create a new worker thread 180 (e.g., worker thread #N+1 180Z) on a new CPU core 170 (e.g., CPU core #Z 170Z) and associate the new worker thread 180 with a new queue having the queue ID (e.g., queue #N+1 160) provided by the auto-scaling manager 210. Once the application completes the above-mentioned task, it may inform the auto-scaling manager 210 that it accepts the scale up recommendation and is ready to accept network traffic via the new queue 160. In response, the auto-scaling manager 210 may initiate updates to the indirection table 140 to distribute future incoming packets across all available queues 160, including the new queue 160. Once the indirection table 140 is updated (to have entries linked to the new queue 160), packets can start being enqueued to the new queue 160 immediately. At this point, the application has successfully scaled up.

If there is state information associated with incoming packets (e.g., TCP session state information or any other session state information), it may be the responsibility of the application to migrate the relevant state information between worker threads 180. To assist the application with the migration of a traffic flow and avoid packet unordering, the active queue management component 150 may mark the last packet assigned to the old queue 160 (using the last packet indicator). When a worker thread 180 receives a packet that is marked as being the last packet of the traffic flow, this means that the traffic flow is to be migrated, and the application may perform the required steps to gracefully migrate the traffic flow session information to the worker thread 180 associated with the new queue 160. Shortly before the auto-scaling manager 210 makes the updates to the indirection table 140, the active queue management component 150 may be informed of the entries being updated/modified and the old and new queue information being affected. Based on that information, the active queue management component 150 may coordinate the graceful migration of the traffic flow from the old queue 160 to the new queue 160 by informing the application of the last packet enqueued to the old queue 160. This may require the active queue management component 150 to override the new queue 160 for a short period of time until the updates to the indirection table 140 have been completed. In an embodiment, the application leverages hash values and queue ID information to detect when a traffic flow has migrated to a new queue due to scaling and/or queue rebalancing. For example, when scaling up and a new queue 160 is added, some traffic flows may need to migrate from one or more old queues to the new queue. The active queue management component 150 may send a last packet indicator with a packet when the association between a hash value and a queue is terminated and the packet is the last packet of that association.

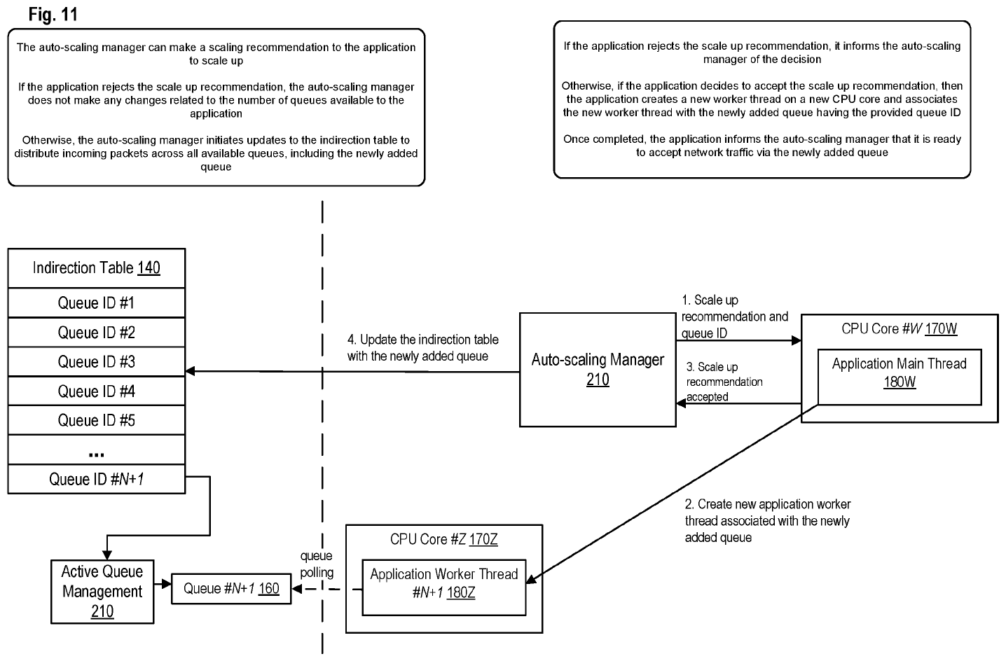

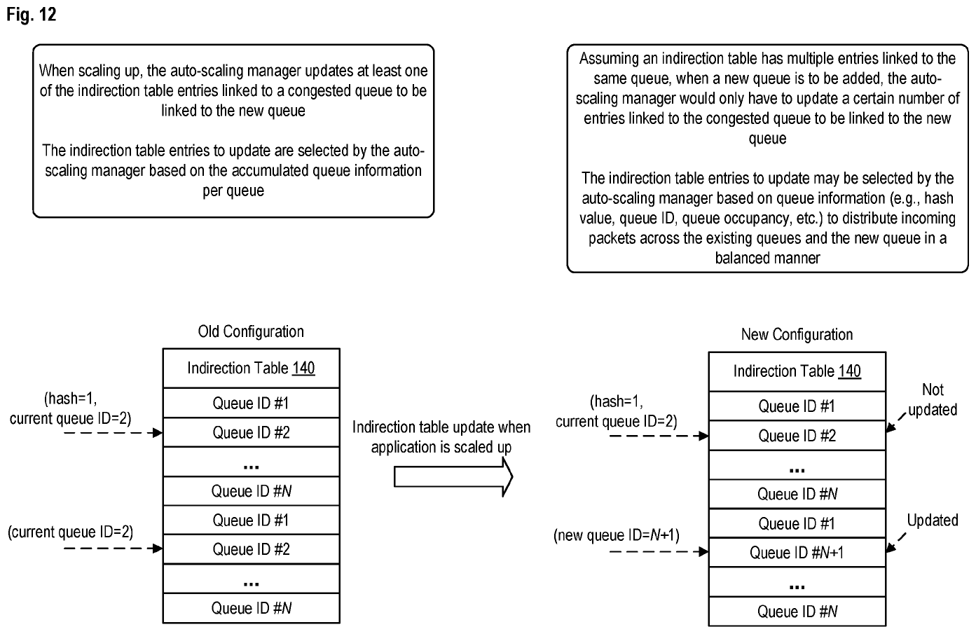

FIG. 12 is a diagram showing an example of how an auto-scaling manager updates the indirection table when the application is scaled up, according to some embodiments.

A typical indirection table, as implemented in modern NICs, includes 128 entries that can each be linked to a queue. Depending on the number of queues that are available, multiple entries may be linked to the same queue. For example, as shown in the diagram, in the old configuration of the indirection table 140, there are two entries (indicated by the dashed arrow) that are each linked to queue #2.

When an application accepts a scale up recommendation, a new queue is added. To receive packets via the newly added queue, the indirection table 140 may be updated such that at least one of the entries of the indirection table 140 is linked to the newly added queue. When considering that the reason for scaling up an application was triggered by conditions reflecting a certain queue being congested, it is deemed important that all the entries of the indirection table 140 that are linked to the congested queue be considered for updating to best distribute future incoming packets across the congested queue and the newly added queue in a balanced manner.

To best balance packet distribution, the auto-scaling manager 210 may leverage the accumulated queue information provided by the worker threads. Assuming the auto-scaling manager collects queue information indicating the hash value (that was used to index into the indirection table 140), the queue ID, and the queue occupancy level, the auto-scaling manager may estimate how packets were distributed across all the table entries linked to the congested queue. The auto-scaling manager 210 may leverage this information to update one or more entries that are linked to congested queue to be linked to the newly added queue such that roughly half of incoming packets that would have been enqueued to the congested queue will be enqueued to the newly added queue. In an embodiment, assuming that packet size information is provided to the auto-scaling manager, traffic bandwidth could be considered when updating the indirection table 140.

When scaling up, the auto-scaling manager 210 may update at least one of the indirection table entries linked to a congested queue to be linked to the new queue. The indirection table entries to update may be selected by the auto-scaling manager 210 based on the accumulated queue information per queue. Assuming an indirection table 140 has multiple entries linked to the same queue, when a new queue is to be added, the auto-scaling manager may update a certain number of entries linked to the congested queue to be linked to the newly added queue. The indirection table entries to be updated may be selected by the auto-scaling manager 210 based on queue information (e.g., hash value, queue ID, queue occupancy, etc.) to distribute future incoming packets across the available queues, including the newly added queue, in a balanced manner.

For example, as shown in the diagram, assuming that queue #2 is congested, the indirection table 140 may be updated such that one of the two entries that are linked to queue #2 is not updated but the other entry is updated to be linked to the newly added queue (queue #N+1 in this example).

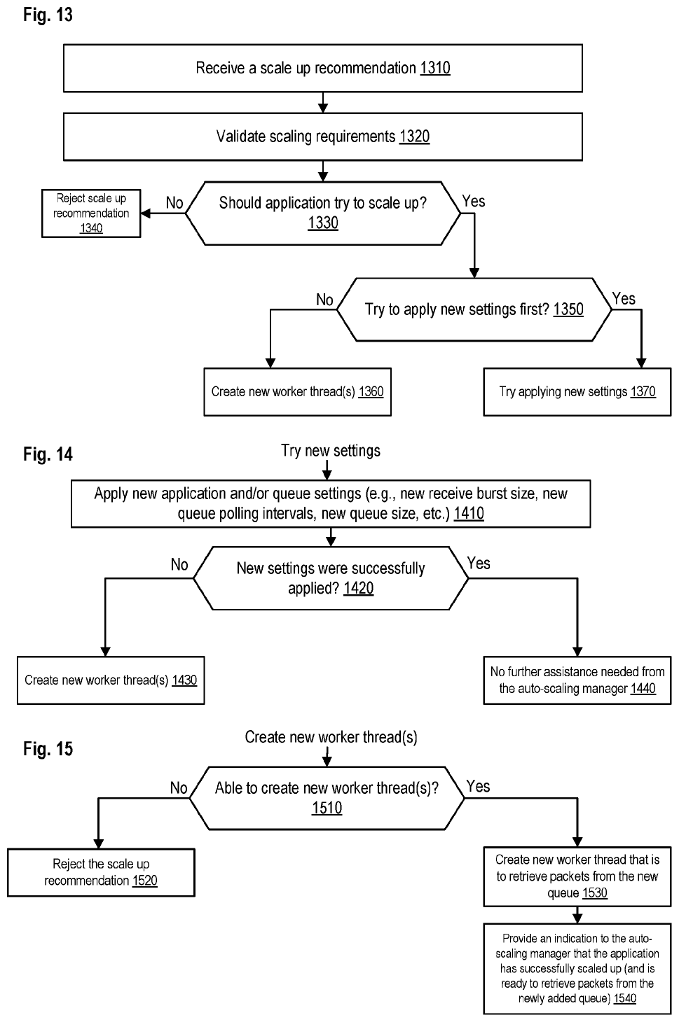

FIG. 13 is a flow diagram showing a method for scaling up, according to some embodiments. The method may be performed by a main worker thread of an application. At operation 1310, the main worker thread receives a scale up recommendation. At operation 1320, the main worker thread validates the scaling requirements. At operation 1330, the main worker thread determines whether the application should be scaled up. If not, at operation 1340, the main worker thread rejects the scale up recommendation. Otherwise, if the main worker thread determines that the application should be scaled up, at operation 1350, the main worker thread determines whether it should try to apply new settings first. If so, at operation 1370, the main worker thread tries applying new settings first. Otherwise, if the main worker thread determines that it should not try to apply new settings first, then at operation 1360, the main worker thread creates new worker thread(s).

The method highlights that while the auto-scaling manager can provide scaling recommendations to applications, it may ultimately be the responsibility of the application itself to accept or reject the scaling recommendation and this decision may depend on the application's specific configuration or requirements.

FIG. 14 is a flow diagram showing a method for trying to apply new settings for scaling up, according to some embodiments. The method may be performed by a main worker thread of an application. At operation 1410, the main worker thread applies new application and/or queue settings (e.g., a new burst size, a new queue polling interval, a new queue size, etc.). At operation 1420, the main worker thread determines whether the new settings were successfully applied. If so, at operation 1440, the main worker thread determines that no further assistance from the auto-scaling manager is needed to scale up. Otherwise, if the main worker thread determines that the new settings were not successfully applied, then at operation 1430, the main worker thread creates new worker thread(s).

For some applications, it might be possible to successfully scale up by changing a few control parameters. For example, an application could decide to change the polling frequency of its allocated queue or the number of packets to retrieve each time from the queue. It could also decide to move its worker thread to a new CPU core that is more dedicated to packet processing. Such changes to the applications settings could potentially be sufficient for the application to process more packets, and be considered to have scaled up successfully.

If the application succeeds to apply the new settings, the application may inform the auto-scaling manager that the application does not need any further assistance from the auto-scaling manager to scale up.

It should be noted that successfully applying new settings does not necessarily mean that the intended effect impacted the scalability of the application. If the new settings do not help with scaling the application, a new scaling recommendation may be expected from the auto-scaling manager at a later time, in which case the application may try other options (e.g., try applying other settings or try creating a worker thread).

FIG. 15 is a flow diagram showing a method for trying to create a new worker thread to scale up an application, according to some embodiments. The method may be performed by a main worker thread of an application. At operation 1510, the main worker thread determines whether it is able to create new worker thread(s). If so, at operation 1530, the main worker thread creates a new worker thread that is to retrieve packets from the newly added queue. At operation 1540, the main worker thread provides an indication to the auto-scaling manager that the application has successfully scaled up (and is ready to retrieve packets from the newly added queue). Returning to operation 1510, if the main worker thread determines that it is not able to create new worker thread(s) (e.g., because there are not enough resources to create a new worker thread), at operation 1520, the main worker thread rejects the scale up recommendation.

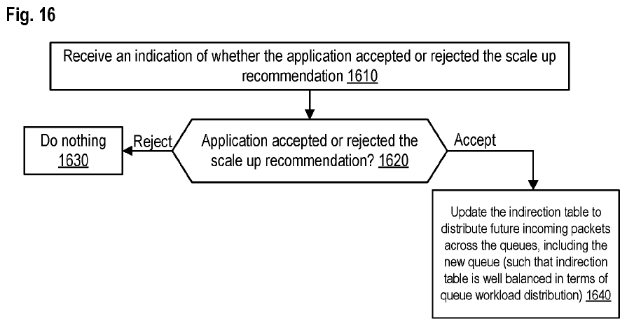

FIG. 16 is a flow diagram showing a method for assisting with an application scale up, according to some embodiments. The method may be performed by an auto-scaling manager. At operation 1610, the auto-scaling manager receives an indication of whether the application accepted or rejected the scale up recommendation. At operation 1620, the auto-scaling manager determines whether the application accepted or rejected the scale up recommendation. If the auto-scaling manager determines that the application accepted the scale up recommendation, then at operation 1640, the auto-scaling manager updates the indirection table to distribute future incoming packets across the queues, including the new queue in a balanced manner (such that the indirection table is well balanced in terms of queue workload distribution). Returning to operation 1620, if the auto-scaling manager determines that the application rejected the scale up recommendation, then at operation 1630, the auto-scaling manager does nothing.

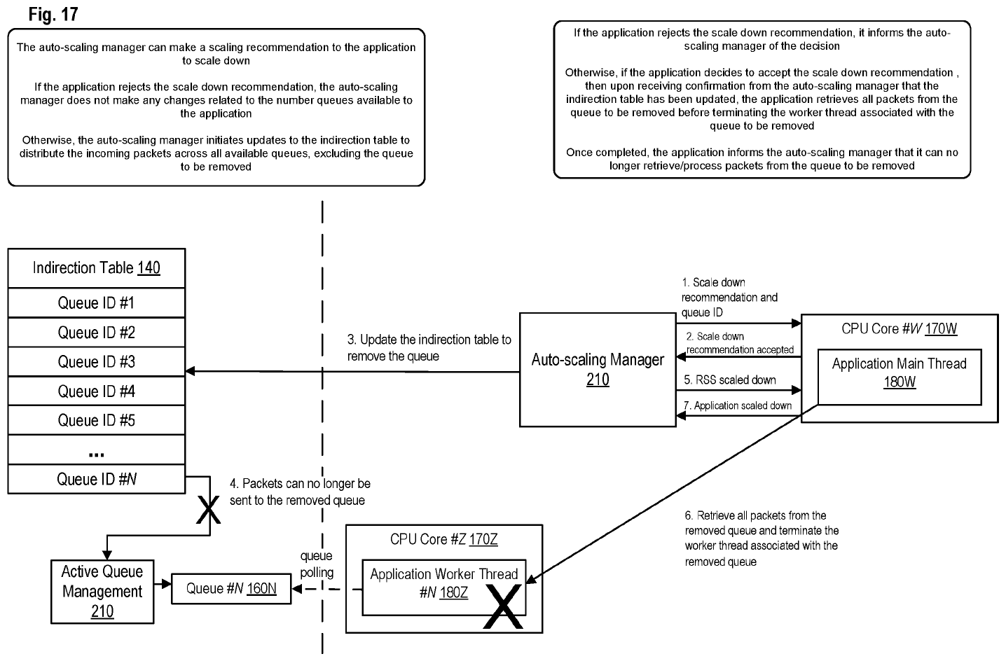

FIG. 17 is a diagram showing operations when an application accepts a scale down recommendation provided by an auto-scaling manager, according to some embodiments. The diagram is similar to the diagram shown in FIG. 4 but highlights a few notable features. It should be understood that the descriptions provided above with reference to FIG. 4 may apply here but those descriptions are not repeated here for sake of brevity.

As noted in the diagram, the auto-scaling manager may provide a scaling recommendation to the application to scale down. If the application decides to reject the scale down recommendation then it may inform the auto-scaling manager 210 of this decision. In response, the auto-scaling manager 210 does not make any changes related to the number of queues available to the application. Otherwise, if the application decides to accept the scale down recommendation then the application may inform the auto-scaling manager 210 that it accepts the scale down recommendation. In response, the auto-scaling manager 210 may initiate updates to the indirection table 140 to distribute future incoming packets across all available queues, excluding the removed queue (e.g., queue #N 160N in this example). Once the indirection table 140 is updated, packets can no longer be enqueued to the removed queue 160. Upon receiving confirmation from the auto-scaling manager 210 that the indirection table 140 has been updated, the application may retrieve all packets from the removed queue 160 before terminating the worker thread associated with the removed queue (e.g., worker thread #N 180Z in this example). Once the application completes the above-mentioned task, it may inform the auto-scaling manager 210 that it can no longer retrieve/process packets from the removed queue 160. At this point, the application has successfully scaled down.

As traffic flows are migrated from the underutilized queue 160 to other queues 160 by updating the indirection table 140, the application might buffer related packets at the other queues until all packets from the underutilized queue 160 are retrieved to maintain packet ordering. If there is state information associated with incoming packets (e.g., TCP session state information or any other session state information), it may be the responsibility of the application to migrate the relevant state information between worker threads 180. Such migration can take place, for example, once all the packets have been retrieved from the underutilized queue 160.

To assist the application with the migration of a traffic flow and avoid packet unordering, the active queue management component 150 may mark the last packet assigned to the old queue 160 (using the last packet indicator). When a worker thread 180 retrieves a packet that is marked as being the last packet of the traffic flow, this means that the traffic flow is to be migrated, and the application may perform the required steps for gracefully migrating the traffic flow session information to the worker thread 180 associated with the new queue 160. Shortly before the auto-scaling manager 210 makes the updates to the indirection table 140, the active queue management component 150 may be informed of the entries being updated/modified and the old and new queue information being affected. Based on that information, the active queue management component 150 may coordinate the graceful migration of the traffic flow from the old queue 160 to the new queue 160 by informing the application of the last packet enqueued to the old queue. This may require the active queue management component 150 to override the new queue 160 for a short period of time until the updates to the indirection table 140 have been completed.

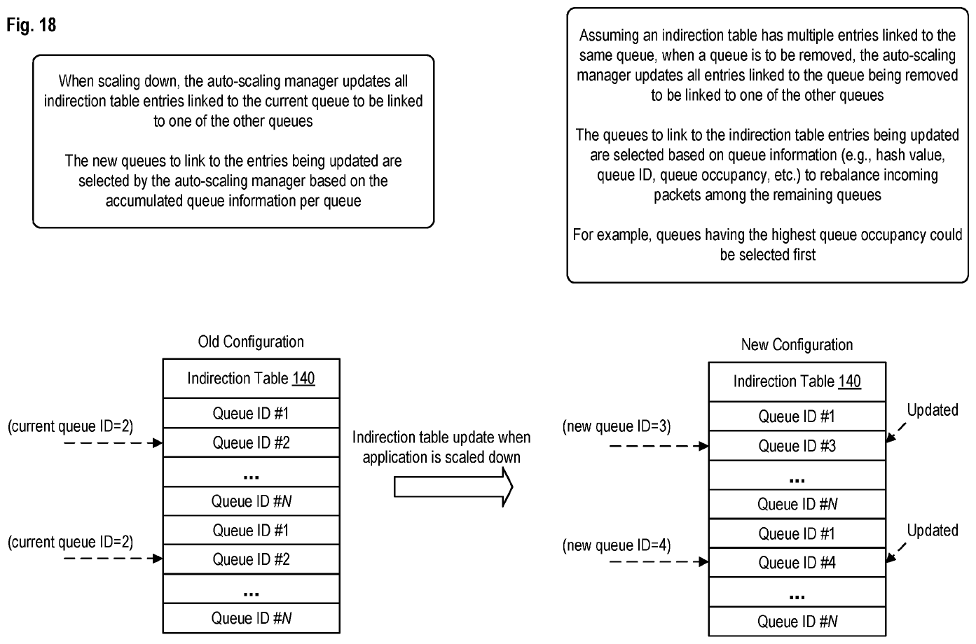

FIG. 18 is a diagram showing an example of how an auto-scaling manager updates the indirection table when the application is scaled down, according to some embodiments.

A typical indirection table, as implemented in modern NICs, includes 128 entries that can each be linked to a queue. Depending on the number of queues that are available, multiple entries may be linked to the same queue. For example, as shown in the diagram, in the old configuration of the indirection table 140, there are two entries (indicated by the dashed arrow) that are each linked to queue #2.

When an application accepts a scale down recommendation, an underutilized queue may be removed. To stop receiving packets via the removed queue, the indirection table 140 may be updated such that all entries of the indirection table that are linked to the removed queue are updated to be linked to one of the remaining available queues. In the process of updating the entries linked to the removed queue, it is deemed important to consider the possibility of rebalancing the packet distribution across the remaining available queues.

To best balance packet distribution, the auto-scaling manager may leverage the accumulated queue information provided by the worker threads. Assuming the auto-scaling manager collects queue information indicating the hash value (that was used to index into the indirection table 140), the queue ID, and the queue occupancy level, the auto-scaling manager may determine how to update the indirection table entries such that future incoming packets are better distributed across all the remaining available queues. For example, the auto-scaling manager 210 may decide to update the entries that are linked to the removed queue to be linked to queues having the highest queue occupancy levels. In an embodiment, assuming that packet size information is provided to the auto-scaling manager 210, traffic bandwidth could be considered when updating the indirection table 140.

When scaling down, the auto-scaling manager may update all indirection table entries linked to the current queue to be linked to one of the other queues. The indirection table entries to update may be selected by the auto-scaling manager based on the accumulated queue information per queue. Assuming an indirection table 140 has multiple entries linked to the same queue, when a queue is to be removed, the auto-scaling manager may update all entries linked to the queue being removed to be linked to one of the other queues. The queues to be linked to the indirection table entries may be selected based on queue information (e.g., hash value, queue ID, queue occupancy, etc.) to distribute future incoming packets across the available queues, excluding the removed queue, in a balanced manner. For example, queues having the highest queue occupancy could be selected first.

For example, as shown in the diagram, assuming that queue #2 is to be removed (e.g., because it is being underutilized), the indirection table 140 may be updated such that both of the entries that are linked to queue #2 are updated to be linked to another queue (queue #3 and queue #4, respectively, in this example).

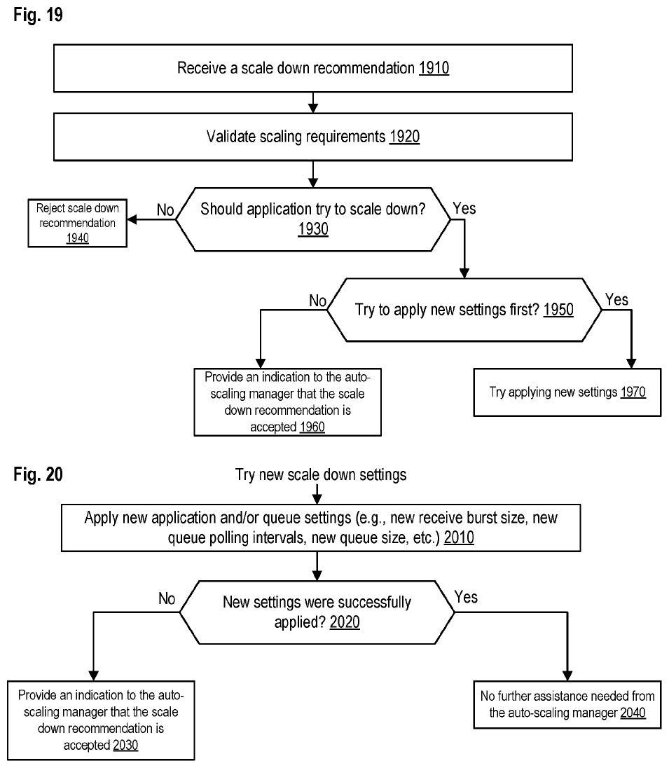

FIG. 19 is a flow diagram showing a method for scaling down, according to some embodiments. The method may be performed by a main worker thread of an application. At operation 1910, the main worker thread receives a scale down recommendation. At operation 1920, the main worker thread validates the scaling requirements. At operation 1930, the main worker thread determines whether the application should be scaled down. If not, at operation 1940, the main worker thread rejects the scale down recommendation. Otherwise, if the main worker thread determines that the application should be scaled down, at operation 1950, the main worker thread determines whether it should try to apply new settings first. If so, at operation 1970, the main worker thread tries applying new settings first. Otherwise, if the main worker thread determines that it should not try to apply new settings first, then at operation 1960, the main worker thread provides an indication to the auto-scaling manager that the scale down recommendation is accepted.

The method highlights that while the auto-scaling manager can provide scaling recommendations to applications, it may ultimately be the responsibility of the application itself to accept or reject the scaling recommendation and this decision may depend on the application's specific configuration or requirements.

FIG. 20 is a flow diagram showing a method for trying to apply new settings for scaling down, according to some embodiments. The method may be performed by a main worker thread of an application. At operation 2010, the main worker thread applies new application and/or queue settings (e.g., a new burst size, a new queue polling interval, a new queue size, etc.). At operation 2020, the main worker thread determines whether the new settings were successfully applied. If so, at operation 2040, the main worker thread determines that no further assistance from the auto-scaling manager is needed to scale down. Otherwise, if the main worker thread determines that the new settings were not successfully applied, then at operation 2030, the main worker thread provides an indication to the auto-scaling manager that the scale down recommendation is accepted.

For some applications, it might be possible to successfully scale down by changing a few control parameters. For example, an application could decide to change the polling frequency of its allocated queue or the number of packets to retrieve each time from the queue. It could also decide to move its worker thread to a new CPU core that is less dedicated to packet processing. Such changes to the applications settings could potentially be sufficient for the application to process less packets and use less system resources, and be considered to have scaled down successfully.

If the application succeeds to apply new settings, the application may inform the auto-scaling manager that the application does not need further assistance from the auto-scaling manager to scale down.

It should be noted that successfully applying new settings does not necessarily mean that the intended effect impacted the scalability of the application. If the new settings do not help with scaling the application, a new scaling recommendation may be expected from the auto-scaling manager at a later time, in which case the application may try other options (e.g., try to apply other settings or try terminating a worker thread).

FIG. 21 is a flow diagram showing a method for assisting with an application scale down, according to some embodiments. The method may be performed by an auto-scaling manager. At operation 2110, the auto-scaling manager receives an indication of whether the application accepted or rejected the scale down recommendation. At operation 2120, the auto-scaling manager determines whether the application accepted or rejected the scale down recommendation. If the auto-scaling manager determines that the application accepted the scale down recommendation, then at operation 2140, the auto-scaling manager updates all entries of the indirection table that are linked to the queue to be removed to be linked to one of the other queues (such that the indirection table is well balanced in terms of queue workload distribution). At operation 2150, the auto-scaling manager provides an indication to the application that the application can complete scale down (e.g., can terminate the worker thread associated with the queue to be removed). Returning to operation 2120, if the auto-scaling manager determines that the application rejected the scale down recommendation, then at operation 2130, the auto-scaling manager does nothing.

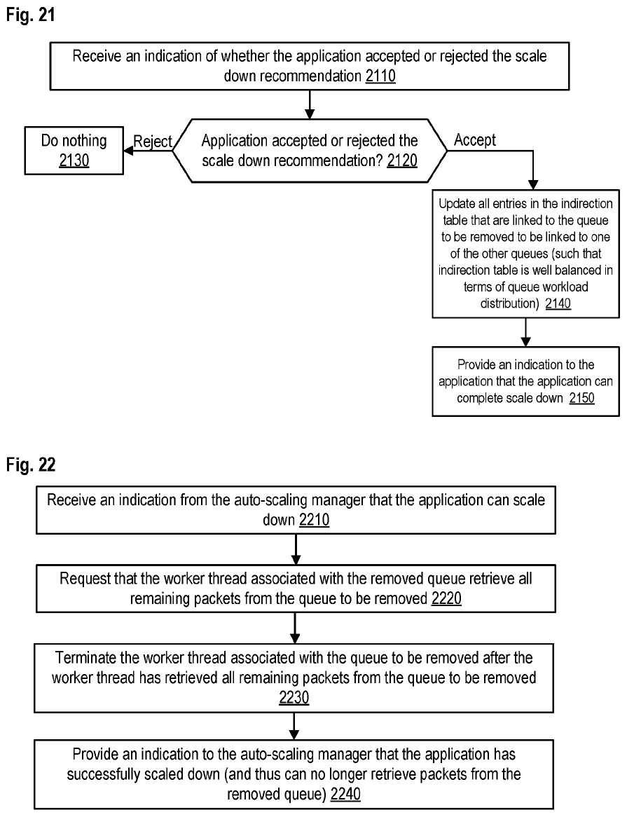

FIG. 22 is a flow diagram showing a method for terminating a worker thread to scale down an application, according to some embodiments. The method may be performed by a main worker thread of the application. At operation 2210, the main worker thread receives an indication from the auto-scaling manager that the application can scale down. At operation 2220, the main worker thread requests that the worker thread associated with the queue to be removed retrieve all remaining packets from the queue to be removed. In an embodiment, the worker thread uses a last packet indicator to identify the last packet of a traffic flow for the queue. At operation 2230, the main worker thread terminates the worker thread associated with the queue to be removed after the worker thread has retrieved all remaining packets from the queue to be removed. At operation 2240, the main worker thread provides an indication to the auto-scaling manager that the application has successfully scaled down (and thus can no longer retrieve packets from the queue to be removed).

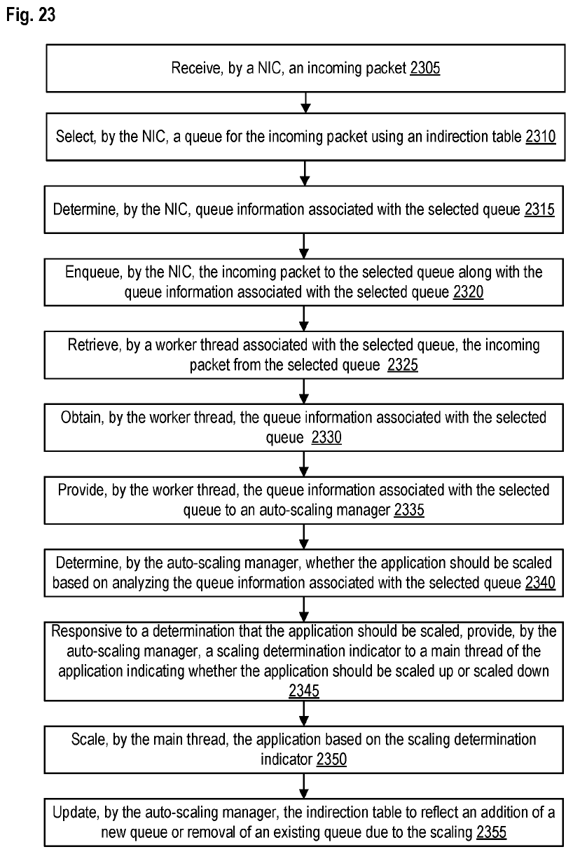

FIG. 23 is a flow diagram showing a method for auto-scaling an application, according to some embodiments. The method may be performed by a computer system that includes a NIC and that executes an application and an auto-scaling manager.

At operation 2305, the NIC receives an incoming packet.

At operation 2310, the NIC selects a queue for the incoming packet using an indirection table (an RSS indirection table).

At operation 2315, the NIC determines queue information associated with the selected queue. In an embodiment, the queue information associated with the selected queue includes a hash value used to index into the indirection table, a queue ID of the selected queue, information regarding a current queue occupancy of the selected queue, and a last packet indicator indicating whether the incoming packet is a last packet of a traffic flow for the selected queue.

At operation 2320, the NIC enqueues the incoming packet to the selected queue along with the queue information associated with the selected queue. In an embodiment, the queue information associated with the selected queue is added to a header of the incoming packet or added to metadata associated with the incoming packet.

At operation 2325, a worker thread of the application associated with the selected queue retrieves the incoming packet from the selected queue.

At operation 2330, the worker thread obtains the queue information associated with the selected queue.

At operation 2335, the worker thread provides the queue information associated with the selected queue to the auto-scaling manager. In an embodiment, the auto-scaling manager stores queue information associated with each of a plurality of queues.

At operation 2340, the auto-scaling manager determines whether the application should be scaled based on analyzing the queue information associated with the selected queue (and/or other queues). In an embodiment, the determination that the application should be scaled is based on determining that a scale up queue occupancy average of the selected queue over a time period exceeds a congestion threshold or determining that a scale down queue occupancy average of the selected queue over a time period is less than a underutilization threshold.

At operation 2345, responsive to a determination that the application should be scaled, the auto-scaling manager provides a scaling determination indicator to a main thread of the application indicating whether the application should be scaled up or scaled down. In an embodiment, the scaling determination indicator represents a scaling recommendation that the main thread is allowed to reject. In an embodiment, the auto-scaling manager waits for a minimum length of time before providing another scaling determination indicator related to the selected queue to the main thread.

In an embodiment, the scaling determination indicator indicates that the application should be scaled up, wherein the application is scaled up by creating a new worker thread for the application that is associated with a new queue of the NIC. In an embodiment, the main thread attempts to apply new settings before creating the new worker thread.

In an embodiment, the scaling determination indicator indicates that the application should be scaled down, wherein the application is scaled down by terminating a worker thread associated with the existing queue. In an embodiment, the main thread attempts to apply new settings before terminating the worker thread associated with the existing queue.

At operation 2350, the main thread scales the application based on the scaling determination indicator.

At operation 2355, the auto-scaling manager updates the indirection table to reflect an addition of a new queue or removal of an existing queue due to the scaling. In an embodiment, when the application is scaled up, updating the indirection table involves updating one or more entries of the indirection table to be linked to the new queue. In an embodiment, when the application is scaled down, updating the indirection table involves updating all entries of the indirection table that are linked to the existing queue to be linked to a different queue. In an embodiment, the main thread waits until all entries of the indirection table that are linked to the existing queue are updated and all remaining packets have been retrieved from the existing queue before terminating the worker thread associated with the existing queue. In an embodiment, the indirection table is updated based on analyzing queue information associated with all available queues. In an embodiment, the auto-scaling manager attempts to rebalance the indirection table (using collected queue information) in lieu of providing the scaling determination indicator to the main thread of the application.

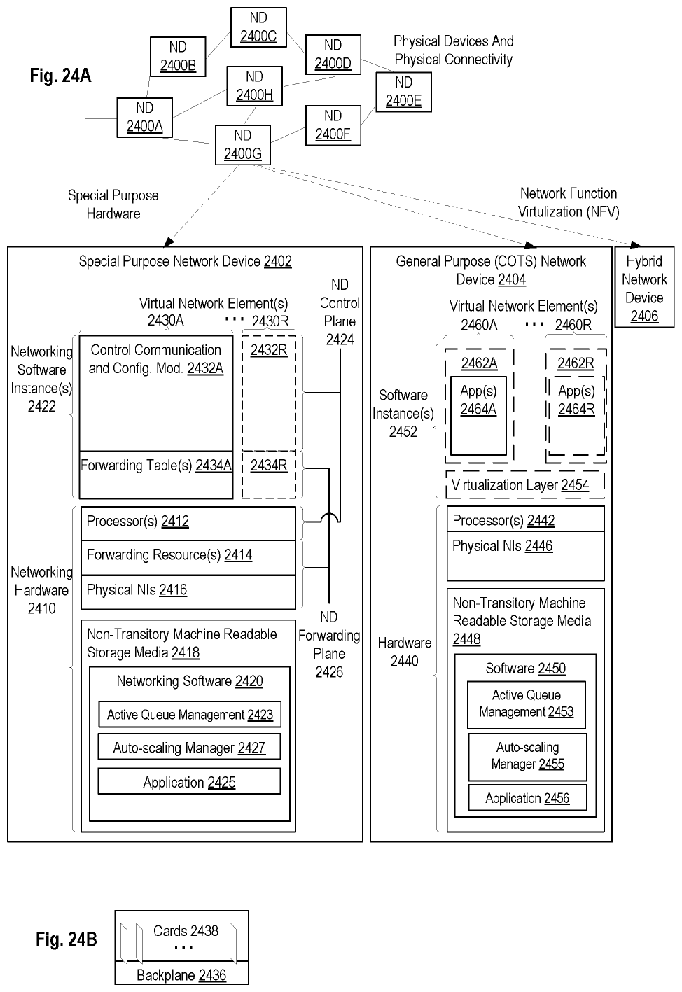

FIG. 24A illustrates connectivity between network devices (NDs) within an exemplary network, as well as three exemplary implementations of the NDs, according to some embodiments. FIG. 24A shows NDs 2400A-H, and their connectivity by way of lines between 2400A-2400B, 2400B-2400C, 2400C-2400D, 2400D-2400E, 2400E-2400F, 2400F-2400G, and 2400A-2400G, as well as between 2400H and each of 2400A, 2400C, 2400D, and 2400G. These NDs are physical devices, and the connectivity between these NDs can be wireless or wired (often referred to as a link). An additional line extending from NDs 2400A, 2400E, and 2400F illustrates that these NDs act as ingress and egress points for the network (and thus, these NDs are sometimes referred to as edge NDs; while the other NDs may be called core NDs).

Two of the exemplary ND implementations in FIG. 24A are: 1) a special-purpose network device 2402 that uses custom application-specific integrated circuits (ASICs) and a special-purpose operating system (OS); and 2) a general-purpose network device 2404 that uses common off-the-shelf (COTS) processors and a standard OS.

The special-purpose network/computing device 2402 includes networking hardware 2410 comprising a set of one or more processor(s) 2412, forwarding resource(s) 2414 (which typically include one or more ASICs and/or network processors), and physical network interfaces (Nis) 2416 (through which network connections are made, such as those shown by the connectivity between NDs 2400A-H), as well as non-transitory machine readable storage media 2418 having stored therein networking software 2420. During operation, the networking software 2420 may be executed by the networking hard ware 2410 to instantiate a set of one or more networking software instance(s) 2422. Each of the networking software instance(s) 2422, and that part of the networking hard ware 2410 that executes that network software instance (be it hardware dedicated to that networking software instance and/or time slices of hardware temporally shared by that networking software instance with others of the networking software instance(s) 2422), form a separate virtual network element 2430A-R. Each of the virtual network element(s) (VNEs) 2430A-R includes a control communication and configuration module 2432A-R (sometimes referred to as a local control module or control communication module) and forwarding table(s) 2434A-R, such that a given virtual network element (e.g., 2430A) includes the control communication and configuration module (e.g., 2432A), a set of one or more forwarding table(s) (e.g., 2434A), and that portion of the networking hard ware 2410 that executes the virtual network element (e.g., 2430A).

The special-purpose network device 2402 is often physically and/or logically considered to include: 1) a ND control plane 2424 (sometimes referred to as a control plane) comprising the processor(s) 2412 that execute the control communication and configuration module(s) 2432A-R; and 2) a ND forwarding plane 2426 (sometimes referred to as a forwarding plane, a data plane, or a media plane) comprising the forwarding resource(s) 2414 that utilize the forwarding table(s) 2434A-R and the physical Nis 2416. By way of example, where the ND is a router (or is implementing routing functionality), the ND control plane 2424 (the processor(s) 2412 executing the control communication and configuration module(s) 2432A-R) is typically responsible for participating in controlling how data (e.g., packets) is to be routed (e.g., the next hop for the data and the outgoing physical NI for that data) and storing that routing information in the forwarding table(s) 2434A-R, and the ND forwarding plane 2426 is responsible for receiving that data on the physical NIs 2416 and forwarding that data out the appropriate ones of the physical Nis 2416 based on the forwarding table(s) 2434A-R.

In an embodiment, software 2420 includes code such as active queue management component 2423, auto-scaling manager component 2427, and/or application 2425, which when executed by networking hardware 910, causes the special-purpose network device 902 to perform operations of one or more embodiments disclosed herein (e.g., to provide application auto-scaling).

In an embodiment, the special-purpose network device 2402 includes a NIC that is configured to perform operations of one or more embodiments disclosed herein (e.g., operations for supporting application auto-scaling).

FIG. 24B illustrates an exemplary way to implement the special-purpose network device 2402, according to some embodiments. FIG. 24B shows a special-purpose network device including cards 2438 (typically hot pluggable). While in some embodiments the cards 2438 are of two types (one or more that operate as the ND forwarding plane 2426 (sometimes called line cards), and one or more that operate to implement the ND control plane 2424 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (Ipsec), Secure Sockets Layer (SSL)/Transport Layer Security (TLS), Intrusion Detection System (IDS), peer-to-peer (P2P), Voice over IP (VOIP) Session Border Controller, Mobile Wireless Gateways (Gateway General Packet Radio Service (GPRS) Support Node (GGSN), Evolved Packet Core (EPC) Gateway)). By way of example, a service card may be used to terminate Ipsec tunnels and execute the attendant authentication and encryption algorithms. These cards are coupled together through one or more interconnect mechanisms illustrated as backplane 24324 (e.g., a first full mesh coupling the line cards and a second full mesh coupling all of the cards).

Returning to FIG. 24A, the general-purpose network/computing device 2404 includes hardware 2440 comprising a set of one or more processor(s) 2442 (which are often COTS processors) and physical Nis 2446, as well as non-transitory machine readable storage media 2448 having stored therein software 2450. During operation, the processor(s) 2442 execute the software 2450 to instantiate one or more sets of one or more applications 2464A-R. While one embodiment does not implement virtualization, alternative embodiments may use different forms of virtualization. For example, in one such alternative embodiment the virtualization layer 2454 represents the kernel of an operating system (or a shim executing on a base operating system) that allows for the creation of multiple instances 2462A-R called software containers that may each be used to execute one (or more) of the sets of applications 2464A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 2454 represents a hypervisor (sometimes referred to as a virtual machine monitor (VMM)) or a hypervisor executing on top of a host operating system, and each of the sets of applications 2464A-R is run on top of a guest operating system within an instance 2462A-R called a virtual machine (which may in some cases be considered a tightly isolated form of software container) that is run on top of the hypervisor-the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 2440, directly on a hypervisor (in which case the unikernel is sometimes described as running within a LibOS virtual machine), or in a software container, embodiments can be implemented fully with unikernels running directly on a hypervisor represented by virtualization layer 2454, unikernels running within software containers represented by instances 2462A-R, or as a combination of unikernels and the above-described techniques (e.g., unikernels and virtual machines both run directly on a hypervisor, unikernels and sets of applications that are run in different software containers).

The instantiation of the one or more sets of one or more applications 2464A-R, as well as virtualization if implemented, are collectively referred to as software instance(s) 2452.

Each set of applications 2464A-R, corresponding virtualization construct (e.g., instance 2462A-R) if implemented, and that part of the hardware 2440 that executes them (be it hard ware dedicated to that execution and/or time slices of hardware temporally shared), forms a separate virtual network element(s) 2460A-R.

The virtual network element(s) 2460A-R perform similar functionality to the virtual network element(s) 2430A-R—e.g., similar to the control communication and configuration module(s) 2432A and forwarding table(s) 2434A (this virtualization of the hardware 2440 is sometimes referred to as network function virtualization (NFV)). Thus, NFV may be used to consolidate many network equipment types onto industry standard high volume server hardware, physical switches, and physical storage, which could be located in data centers, and customer premise equipment (CPE). While embodiments are illustrated with each instance 2462A-R corresponding to one VNE 2460A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 2462A-R to VNEs also apply to embodiments where such a finer level of granularity and/or unikernels are used.

In certain embodiments, the virtualization layer 2454 includes a virtual switch that provides similar forwarding services as a physical Ethernet switch. Specifically, this virtual switch forwards traffic between instances 2462A-R and the physical NI(s) 2446, as well as optionally between the instances 2462A-R; in addition, this virtual switch may enforce network isolation between the VNEs 2460A-R that by policy are not permitted to communicate with each other (e.g., by honoring virtual local area networks (VLANs)).

In one embodiment, software 2450 includes code such as active queue management component 2453, auto-scaling manager component 2455, and/or application 2456, which when executed by processor(s) 2442, causes the general purpose network device 2404 to perform operations of one or more embodiments disclosed herein (e.g., to provide application auto-scaling).

In an embodiment, the general-purpose network device 2404 includes a NIC that is configured to perform operations of one or more embodiments disclosed herein (e.g., operations for supporting application auto-scaling).

The third exemplary ND implementation in FIG. 24A is a hybrid network device 2406, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 2402) could provide for para-virtualization to the networking hard ware present in the hybrid network device 2406.

In an embodiment, the hybrid network device 2406 includes a NIC that is configured to perform operations of one or more embodiments disclosed herein (e.g., operations for supporting application auto-scaling).

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 2430A-R, VNEs 2460A-R, and those in the hybrid network device 2406) receives data on the physical Nis (e.g., 2416, 2446) and forwards that data out the appropriate ones of the physical Nis (e.g., 2416, 2446). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

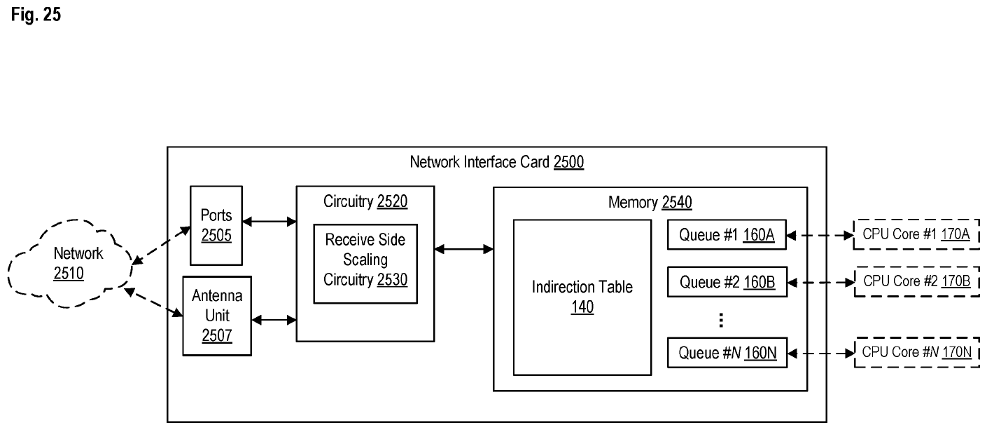

FIG. 25 is a diagram showing a NIC, according to some embodiments. As shown in the diagram, the NIC 2500 includes ports 2505, antenna unit 2507, circuitry 2520, and memory 2540. The ports 2505 may allow the network interface card 2500 to connect to a network 2510 over a wired connection (e.g., using a cable that is plugged into one or more of the ports 2505). The antenna unit 2507 may allow the network interface card 2500 to connect to the network 2510 over a wireless connection (e.g., using WiFi). While the NIC 2500 shown in the diagram includes both ports 2505 and an antenna unit 2507, some NICs might only have one or the other. The circuitry 2520 may be coupled to the ports 2505 and /r the antenna unit 2507. The circuitry 2520 may process network traffic that is received from the network 2510 via the ports 2505 and/or the antenna unit 2507. As shown in the diagram, the circuitry 2520 may include receive side scaling circuitry 2530 to perform receive side scaling operations, as disclosed herein. The circuitry 2520 may be coupled to the memory 2540. The receive side scaling circuitry 2530 may store/maintain/use an indirection table 140 and queues 160A-N in the memory 2540. Each of the queues 160A-N may be associated with one of the CPU cores 170A-N (or an application worker thread being executed on he CPU core 170). The receive side scaling circuitry 2530 may perform operations for supporting application auto-scaling, as disclosed herein.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments are not described with reference to any particular programming language. It will be appreciated that a variety of programming languages may be used to implement the teachings of embodiments as described herein.

An embodiment may be an article of manufacture in which a non-transitory machine-readable storage medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hard wired logic (e.g., dedicated digital filter blocks and state machines). Those operations might alternatively be performed by any combination of programmed data processing components and fixed hard wired circuit components.

Throughout the description, embodiments have been presented through flow diagrams. It will be appreciated that the order of transactions and transactions described in these flow diagrams are only intended for illustrative purposes and not intended to be limiting. One having ordinary skill in the art would recognize that variations can be made to the flow diagrams.

In the foregoing specification, embodiments have been described with reference to specific exemplary embodiments thereof. It will be evident that various modifications may be made thereto without departing from the broader spirit and scope of the disclosure provided herein. The specification and drawings are, accordingly, to be regarded in an illustrative sense rather than a restrictive sense.

1. A method performed by a computing system for auto-scaling an application, the method comprising:
receiving, by a network interface card (NIC), an incoming packet;
selecting, by the NIC, a queue for the incoming packet using an indirection table;
determining, by the NIC, queue information associated with the selected queue;
enqueuing, by the NIC, the incoming packet to the selected queue along with the queue information associated with the selected queue;
retrieving, by a worker thread of the application associated with the selected queue, the incoming packet from the selected queue;
obtaining, by the worker thread, the queue information associated with the selected queue;
providing, by the worker thread, the queue information associated with the selected queue to an auto-scaling manager;
determining, by the auto-scaling manager, whether the application should be scaled based on analyzing the queue information associated with the selected queue;
responsive to a determination that the application should be scaled, providing, by the auto-scaling manager, a scaling determination indicator to a main thread of the application indicating whether the application should be scaled up or scaled down;
scaling, by the main thread, the application based on the scaling determination indicator; and
updating, by the auto-scaling manager, the indirection table to reflect an addition of a new queue or a removal of an existing queue due to the scaling.

2. The method of claim 1, wherein the queue information associated with the selected queue includes a hash value used to index into the indirection table, a queue ID of the selected queue, information regarding a current queue occupancy of the selected queue, and a last packet indicator indicating whether the incoming packet is a last packet of a traffic flow for the selected queue.

3. The method of claim 1, wherein the queue information associated with the selected queue is added to a header of the incoming packet or added to metadata associated with the incoming packet.

4. The method of claim 1, wherein the scaling determination indicator represents a scaling recommendation that the main thread is allowed to reject.

5. The method of claim 1, wherein the scaling determination indicator indicates that the application should be scaled up, wherein the application is scaled up by creating a new worker thread for the application that is associated with a new queue of the NIC.

6. The method of claim 5, wherein the main thread attempts to apply new settings before creating the new worker thread.

7. The method of claim 5, wherein updating the indirection table involves updating one or more entries of the indirection table to be linked to the new queue.

8. The method of claim 1, wherein the scaling determination indicator indicates that the application should be scaled down, wherein the application is scaled down by terminating a worker thread associated with the existing queue.

9. The method of claim 8, wherein the main thread attempts to apply new settings before terminating the worker thread associated with the existing queue.

10. The method of claim 8, wherein updating the indirection table involves updating all entries of the indirection table that are linked to the existing queue to be linked to a different queue.

11. The method of claim 10, further comprising:
waiting, by the main thread, until all entries of the indirection table that are linked to the existing queue are updated and all remaining packets have been retrieved from the existing queue before terminating the worker thread associated with the existing queue.

12. The method of claim 1, wherein the determination that the application should be scaled is based on determining that a scale up queue occupancy average of the selected queue over a time period exceeds a congestion threshold or determining that a scale down queue occupancy average of the selected queue over a time period is less than a underutilization threshold.

13. The method of claim 11, wherein the auto-scaling manager waits for a minimum length of time before providing another scaling determination indicator related to the selected queue to the main thread.

14. (canceled)

15. (canceled)

16. A method performed by an auto-scaling manager implemented by a computing system to determine whether an application should be scaled, the method comprising:
obtaining queue information associated with one or more queues of a network interface card (NIC), wherein each of the one or more queues is associated with a worker thread of the application;
determining whether the application should be scaled based on analyzing the queue information associated with the one or more queues; and
responsive to a determination that the application should be scaled, providing a scaling determination indicator to a main thread of the application indicating whether the application should be scaled up or scaled down.

17. The method of claim 16, wherein the queue information associated with a queue from the one or more queues includes a hash value used to index into an indirection table of the NIC, a queue ID of the queue, information regarding a current queue occupancy of the queue, and a last packet indicator indicating whether a packet is a last packet of a traffic flow for the queue.

18. The method of claim 16, wherein the scaling determination indicator represents a scaling recommendation that the main thread is allowed to reject.

19.-21. (canceled)

22. A computing device to implement an auto-scaling manager to determine whether an application should be scaled, the computing device comprising:
a set of one or more processors; and
a non-transitory machine-readable storage medium containing instructions that, if executed by the set of one or more processors, causes the auto-scaling manager to:
obtain queue information associated with one or more queues of a network interface card (NIC), wherein each of the one or more queues is associated with a worker thread of the application;
determine whether the application should be scaled based on analyzing the queue information associated with the one or more queues; and
responsive to a determination that the application should be scaled, provide a scaling determination indicator to a main thread of the application indicating whether the application should be scaled up or scaled down.

23.-30. (canceled)

31. The computing device of claim 22, wherein the queue information associated with a queue from the one or more queues includes a hash value used to index into an indirection table of the NIC, a queue ID of the queue, information regarding a current queue occupancy of the queue, and a last packet indicator indicating whether a packet is a last packet of a traffic flow for the queue.
